(19) United States
(12) Patent Application Publication
(10) Pub. No.: US 2024/0389195 A1
(43) Pub. Date: Nov. 21, 2024

(54) METHODS AND SYSTEMS FOR SHARING EMERGENCY MULTIMEDIA FEED

(71) Applicant: RapidSOS, Inc., New York, NY (US)

(72) Inventor: James Patrick Olejar, Fort Lauderdale, FL (US)

(21) Appl. No.: 18/665,801

(22) Filed: May 16, 2024

Related U.S. Application Data
(60) Provisional application No. 63/466,927, filed on May 16, 2023.

(51) Int. Cl. H04W 76/50; H04M 1/72418; H04W 76/15

(52) U.S. Cl. CPC H04W 76/50; H04M 1/72418; H04W 76/15

(57) ABSTRACT

Disclosed herein is an emergency management cloud server that facilitates data exchange between various data sources and various data recipients. Also disclosed herein is a responder dispatch coordination system (RDC) that facilitates communications between emergency service providers and emergency responders to aid emergency response networks and systems in responding to emergencies. Also disclosed herein are various ways in which the cloud server provides methods and systems for sharing streams of multimedia between users in an emergency, an emergency service provider (ESP), and emergency responders.

### CROSS-REFERENCE TO RELATED APPLICATION(S)

This application claims the benefit of U.S. Provisional Application No. 63/466,927 filed May 16, 2023, which is incorporated herein by reference in its entirety.

### TECHNICAL FIELD

This disclosure relates generally to electronic methods and systems of communication during emergencies.

### BACKGROUND

A person in an emergency may request help using a mobile communication device such as a cell phone to dial a designated emergency number like 9-1-1 or a direct access phone number for the local emergency service provider (e.g. an emergency dispatch center). Traditionally, this call is assigned to one or more emergency responders by the emergency service provider, and the caller's estimated location (generally either the location of a nearby cell tower or a triangulation from the location of three or more nearby cell towers) is provided to the emergency service provider by the caller's wireless carrier (e.g., AT&T). Alternatively, the caller may provide their location to the emergency service provider by verbally speaking their location over the phone. Unfortunately, many emergency callers are unaware of their precise location or otherwise unable to verbalize it.

However, modern technologies have enabled the development and implementation of previously unimaginable or unachievable emergency services. For example, modern communication devices are capable of generating highly accurate, real-time locations (e.g., device-based hybrid locations) during emergency situations (e.g., in response to an emergency number being dialed) and transmitting the locations to emergency management systems and emergency service providers. Emergency service providers can then use these accurate locations to more quickly locate and dispatch emergency assistance to emergency callers. In another example, devices such as surveillance cameras can capture images, videos, or audio that can be shared in real-time with emergency management systems and emergency service providers to provide emergency service providers with situational awareness that they did not have access to in the past. Similarly, modern technologies and communication devices allow for new ways of engaging with the on-the-ground emergency responders who respond to emergencies, such as firefighters and police officers. Digitally sharing emergency related data with emergency responders, and digitally receiving emergency related data from emergency responders, can make emergency response as a whole more effective and efficient.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing.

FIG. 1 depicts a diagram of an embodiment of an emergency management cloud server;

FIG. 2 illustrates an embodiment of a graphical user interface (GUI) provided by an emergency response application;

FIG. 3A depicts a diagram of an embodiment of systems and processes for receiving and transmitting emergency data by an emergency management cloud server;

FIG. 3B depicts a diagram of an embodiments of systems and processes for receiving and transmitting emergency data by an emergency management cloud server;

FIG. 4 depicts a diagram of an embodiment of a responder dispatch coordination (RDC) within the emergency response ecosystem;

FIG. 5 depicts a diagram of an embodiment of an RDC in communication within one or more primary emergency service providers (ESPs), one or more secondary ESPs, and one or more emergency responders;

FIG. 6A illustrates an embodiment of a mobile application on a user device of an emergency responder;

FIG. 6B illustrates an embodiment of a mobile application on a user device of an emergency responder,

FIG. 7 illustrates an embodiment of a GUI provided by a secondary ESP application;

FIG. 8 illustrates an embodiment of a GUI provided by a primary ESP application;

FIG. 9A depicts an embodiment of an RDC in communication with the cloud server;

FIG. 9B depicts an embodiment of an RDC in communication with the cloud server;

FIG. 10 illustrates an embodiment of a GUI provided by an emergency responder application;

FIG. 11 illustrates an embodiment of a GUI provided by an emergency responder application;

FIG. 12 illustrates an example of an emergency responder responding to an emergency;

FIG. 13A an embodiment of a GUI provided by an emergency responder application;

FIG. 13B an embodiment of a GUI provided by an emergency responder application;

FIG. 14 illustrates an embodiment of a GUI provided by an emergency response application:

FIG. 15 depicts a diagram of an embodiment of a system for sharing multimedia captured by an emergency responder with an ESP;

FIG. 16 illustrates an embodiment of a GUI provided by an emergency response application for an ESP user to start a communication channel with a user device;

FIG. 17 illustrates an embodiment of a GUI provided by an emergency response application for an ESP user to confirm the location of the user device;

FIG. 18 illustrates an embodiment of a GUI provided by an emergency response application for sending a multimedia request to a user device;

FIG. 19 illustrates an embodiment of a GUI provided by a mobile application on a user device for sending stream of multimedia;

FIG. 20 illustrates an embodiment of a GUI provided by a mobile application on a user device for sending a stream of multimedia;

FIG. 21 illustrates an embodiment of a GUI provided by an emergency response application for receiving a stream of multimedia from a user device; and

FIG. 22 illustrates an embodiment of a GUI provided by a mobile application for receiving a stream of multimedia from a user device.

### DETAILED DESCRIPTION

Disclosed herein are systems, devices, media, and methods for providing enhanced emergency communications and functions. Embodiments of the present disclosure take advantage of technological advancements that have allowed for mobile communication devices to generate accurate locations by incorporating multiple technologies embedded in the devices, such as GPS, Wi-Fi, and Bluetooth to create device-based hybrid locations. Device-based hybrid locations are locations calculated on an electronic or communication device, as opposed to locations calculated using a network (e.g., a carrier network). Device-based hybrid locations can be generated using GPS, network-based technologies, Wi-Fi access points, Bluetooth beacons, barometric pressure sensors, dead reckoning using accelerometers and gyrometers, and a variety of crowdsourced and proprietary databases that device operating systems providers are running to enhance location technology. These device-based hybrid locations can be quickly generated during emergency calls. Furthermore, mobile communication devices (e.g., mobile phones, wearables, IoT devices, smart home devices, vehicle computers, etc.) are often capable of generating or storing additional information that may be useful in responding to emergency situations, such as health data or medical histories. For example, during an emergency, a modern mobile communication device may have access to an implicated person's blood type, preexisting medical conditions, or even the implicated person's current heartrate. In some embodiments, the mobile communication device has access to data from sensors (e.g., health or environmental sensors). For example, a video feed of the emergency via a connected surveillance camera can provide valuable situational awareness regarding the emergency.

In one aspect, disclosed herein are systems and methods for sharing stream of multimedia (audio, video, etc.) from a user device (e.g., a user in an emergency or an emergency responder) with a public safety agency such as PSAP, via an emergency management cloud server. Previously, a caller on an emergency call was only able to share audio information to a telecommunicator, which had to be entered and passed on to dispatchers and responders who provide emergency response on the ground. It is desirable for obtaining multimedia feed from the emergency with rich situational awareness information for effective and efficient emergency response.

It is said that a picture is worth a thousand words and this can be even more true for a video feed. The situational awareness information that can be gleaned from multimedia feed may vary. In some cases, the visual of the emergency can allow public safety personnel, with or without the help of artificial intelligence, identify a person with a weapon a broken window, a car on fire, etc, which can help in identifying the type and priority (e.g., critical, non-critical, non-emergency) of the emergency. For example, it is important for emergency responders to receive visual attributes of a patient in a medical emergency. In addition, the situation around the emergency may be important for planning the response, such as advising the caller on what to do while waiting for help, what is a feasible approach to a building on fire, etc. It is anticipated that providing such systems and methods for sharing the multimedia feed from the emergency to multiple stakeholders in the public safety pipeline (callers, primary, secondary or responders) will be particularly advantageous.

While video calling technology is widely available, this technology has not been adopted in public safety for various reasons. There are some challenges that have to be overcome to be able to provide access to the multimedia feed starting with providing the feed to the right stakeholders at the relevant time. In addition, getting consent of the person who is generating the multimedia feed may be important. The technology for accessing and transmitting large files associated with multimedia feeds can be challenging.

In one aspect, disclosed herein is an emergency management cloud server capable of receiving emergency data (e.g., device-based hybrid locations and additional emergency information, such as health data, medical data, and multimedia) from smart devices and systems (e.g., mobile phones and IoT devices) and transmitting the emergency data to emergency service providers (ESPs) to assist the ESPs in responding to emergencies. However, while device-based hybrid locations are generally more accurate and more quickly generated than the locations estimated by wireless carriers (as mentioned above), device-based hybrid locations are generally only available for emergency calls made by mobile phones. Thus, because ESPs receive emergency calls from both mobile phone and landline phones, if the cloud server were to only provide device-based hybrid locations to an ESP, the cloud server would not be providing locations to the ESP for all of the emergency calls received by the ESP. There is therefore a desire for the cloud server to source and ingest locations associated with landline phones that make emergency calls to ESPs, so that the cloud server can provide locations to an ESP for all of the emergency calls that the ESP receives. In another aspect, then, disclosed herein is a cloud server capable of receiving emergency data from smart devices and systems and emergency call data (e.g., data associated with emergency calls made to ESPs) and transmitting both the emergency data and the emergency call data to the ESPs to assist the ESPs in responding to emergencies.

In some aspects, disclosed herein is a system for providing emergency response assistance to emergency responders, the system including: (a) an emergency management cloud server (EMCS) configured to receive an emergency alert including a user identifier and an emergency location associated with the user identifier; and (b) a responder dispatch coordination system (RDC) configured to: (i) receive, from an emergency service provider (ESP), a dispatch request including the user identifier; (ii) transmit, to the cloud server, an emergency data request including the user identifier; (iii) receive, from the cloud server, emergency data including the emergency location; and (iv) transmit, to an emergency responder application executed on a responder device, the emergency data including the emergency location for display within a graphical user interface (GUI) of the emergency responder application. In some embodiments, the emergency alert is associated with an emergency call routed to the ESP. In some embodiments, the emergency data further includes personal data or medical data associated with the user identifier. In some embodiments, the emergency data further includes sensor data associated with the user identifier. In some embodiments, the cloud server comprises the RDC. In some embodiments, the cloud server is communicatively coupled to the RDC. In some embodiments, the RDC is further configured to extract the user identifier from the dispatch request. In some embodiments, the RDC is further configured to: (a) receive the dispatch request from the ESP in the form of an email; and (b) extract the user identifier from contents of the email. In some embodiments, the RDC is further configured to: (a) receive the dispatch request from the ESP in the form of an audio message over a radio signal; and (b) extract the user identifier from the audio message. In some embodiments, the RDC is further configured to record the audio message and provide access to the audio message to the responder device. In some embodiments, the RDC is further configured to provide access to the audio message to the responder device through the emergency responder application. In some embodiments, the cloud server is further configured to establish, between the cloud server and an emergency response application accessed on a computing device associated with the ESP, an emergency communication link. In some embodiments, the RDC is further configured to: (a) receive, from the emergency responder application, a selection of the dispatch request from within the GUI of the emergency responder application; (b) receive, from the emergency responder application, a responder identifier associated with the responder device and a responder location associated with the responder identifier; and (c) transmit, to the cloud server, the responder identifier and the responder location. In some embodiments, the responder location is generated by the responder device. In some embodiments, the cloud server is further configured to transmit, through the emergency communication link, the responder location to the ESP for display within a GUI of an emergency response application accessed on a computing device associated with the ESP. In some embodiments, the cloud server is further configured to provide the emergency response application to the ESP. In some embodiments, the cloud server provides the emergency response application to the ESP in the form of a website or a web application accessible via a standard web browser. In some embodiments, the emergency response application is not provided to the ESP by the cloud server. In some embodiments, the emergency response application is a computer aided dispatch (CAD) system. In some embodiments, the responder location is displayed within an interactive map within the GUI of the emergency response application. In some embodiments, the cloud server is further configured to transmit, through the emergency communication link, the emergency location to the ESP for display within the GUI of the emergency response application and wherein the emergency location and the responder location are displayed within the interactive map within the GUI of the emergency response application simultaneously. In some embodiments, the RDC is further configured to: (a) receive, from the emergency response application, an updated responder location associated with the responder identifier; and (b) transmit, to the cloud server, the updated responder location. In some embodiments, the cloud server is further configured to transmit, through the emergency communication link, the updated responder location to the ESP for display within the interactive map within the GUI of the emergency response application. In some embodiments, the responder location and the updated responder location are displayed within the interactive map within the GUI of the emergency response application simultaneously. In some embodiments, the RDC is further configured to: (a) receive, from the emergency responder application, an audio or video recording; and (b) transmit, to the cloud server, the audio or video recording. In some embodiments, the cloud server is further configured to transmit, through the emergency communication link, the audio or video recording to the ESP for display within a GUI of an emergency response application accessed on a computing device associated with the ESP. In some embodiments, the audio or video recording is captured by the responder device. In some embodiments, the audio or video recording is streamed to the ESP through the emergency communication link. In some embodiments, the cloud server is further configured to: (a) receive an updated emergency location associated with the user identifier; and (b) transmit, to the RDC, the updated emergency location for transmission to and display within the GUI of the emergency responder application. In some embodiments, the emergency location and the updated emergency location are displayed within the GUI of the emergency responder application simultaneously. In some embodiments, RDC is further configured to provide the emergency responder application to the responder device. In some embodiments, the emergency responder application is not provided to the responder device by the RDC. In some embodiments, the cloud server is further configured to establish, between the emergency responder application and an emergency response application accessed on a computing device associated with the ESP, an emergency communication session. In some embodiments, the cloud server is further configured to facilitate, through the emergency communication session, an exchange of one or more text-based messages between the emergency responder application accessed on the responder device and the emergency response application accessed on the computing device associated with the ESP. In some embodiments, the cloud server is further configured to facilitate, through the emergency communication session, a voice call between the emergency responder application accessed on the responder device and the emergency response application accessed on the computing device associated with the ESP. In some embodiments, the voice call is a voice over internet protocol (VoIP) call. In some embodiments, the emergency responder application is further configured to transmit, through the emergency communication session, a responder location associated with the responder device for display within a GUI of the emergency response application. In some embodiments, the responder location is generated by the responder device. In some embodiments, the emergency responder application is further configured to transmit, through the emergency communication session, an updated responder location associated with the responder device for display within the GUI of the emergency response application. In some embodiments, the responder location and the updated responder location are displayed within the GUI of the emergency response application simultaneously. In some embodiments, the emergency responder application is further configured to transmit, through the emergency communication session, an audio or video recording for display within a GUI of the emergency response application. In some embodiments, the audio or video recording is generated by the responder device. In some embodiments, the audio or video recording is streamed from the responder device to the emergency response application through the emergency communication session.

In some aspects, disclosed herein is a method for providing emergency response assistance to emergency responders by a responder dispatch coordination system (RDC), the method comprising: (a) receiving, from an emergency service provider (ESP), a dispatch request comprising a user identifier; (b) transmitting, to an emergency response data platform (cloud server), an emergency data request comprising the user identifier; (c) receiving, from the cloud server, emergency data comprising an emergency location associated with the user identifier; and (d) transmitting, to an emergency responder application accessed on a responder device, the emergency data comprising the emergency location for display within a graphical user interface (GUI) of the emergency responder application. In some embodiments, the emergency location is displayed within an interactive map within the GUI of the emergency responder application. In some embodiments, the emergency data further comprises personal data or medical data associated with the user identifier. In some embodiments, the emergency data further comprises sensor data associated with the user identifier. In some embodiments, the method further comprises extracting the user identifier from the dispatch request. In some embodiments, the dispatch request is received in the form of an email and wherein the user identifier is extracted from contents of the email. In some embodiments, the dispatch request is received in the form of an audio message over a radio signal and wherein the user identifier is extracted from the audio message. In some embodiments, the method further comprises recording the audio message and providing access to the audio message to the responder device. In some embodiments, the method further comprises providing access to the audio message to the responder device through the emergency responder application. In some embodiments, the emergency location is received by the cloud server within an emergency alert associated with an emergency call routed to the ESP. In some embodiments, the cloud server comprises the RDC. In some embodiments, the RDC is communicatively coupled to the cloud server. In some embodiments, the method further comprises: (a) receiving, from the cloud server, an updated emergency location associated with the user identifier; and (b) transmitting, to the emergency responder application, the updated emergency location for display within the GUI of the emergency responder application. In some embodiments, the emergency location and the updated emergency location are displayed within an interactive map within the GUI of the emergency responder application simultaneously. In some embodiments, the method further comprises: (a) receiving, from the emergency responder application, a selection of the dispatch request from within the GUI of the emergency responder application; (b) receiving, from the emergency responder application, a responder identifier associated with the responder device and a responder location associated with the responder identifier; and (c) transmitting, to the cloud server, the responder identifier and the responder location for transmission to the ESP. In some embodiments, the responder location is generated by the responder device. In some embodiments, the method further comprises establishing, through the cloud server, an emergency communication session between the emergency responder application and an emergency response application accessed on computing device associated with the ESP. In some embodiments, the responder identifier and the responder location are transmitted to the ESP through the emergency communication session. In some embodiments, the responder location is displayed within an interactive map within a GUI of the emergency response application. In some embodiments, the method further comprises: (a) receiving, from the emergency responder application, an updated responder location associated with the responder identifier; and (b) transmitting, to the cloud server, the updated responder location for transmission to the ESP. In some embodiments, the updated responder location is transmitted to the ESP through the emergency communication session. In some embodiments, the updated responder location is displayed within the interactive map within the GUI of the emergency response application. In some embodiments, the responder location and the updated responder location are displayed within the GUI of the emergency response application simultaneously. In some embodiments, the method further comprises: (a) receiving, from the emergency responder application, an audio or video recording; and (b) transmitting, to the cloud server, the audio or video recording for transmission to the ESP. In some embodiments, the audio or video recording is transmitted to the ESP through the emergency communication session. In some embodiments, the audio or video recording is generated by the responder device. In some embodiments, the audio or video recording is streamed from the emergency responder application to the emergency response application through the emergency communication session. In some embodiments, the method further comprises facilitating, through the emergency communication session, an exchange of one or more text-based messages between the emergency responder application accessed on the responder device and the emergency response application accessed on the computing device associated with the ESP. In some embodiments, the method further comprises facilitating, through the emergency communication session, a voice call between the emergency responder application accessed on the responder device and the emergency response application accessed on the computing device associated with the ESP. In some embodiments, the voice call is a voice over internet protocol (VoIP) call. In some embodiments, the emergency response application is provided to the ESP by the cloud server. In some embodiments, the emergency response application is a website or a web application accessible via a standard web browser. In some embodiments, the emergency response application is not provided to the ESP by the cloud server. In some embodiments, the emergency response application is a computer aided dispatch (CAD) system. In some embodiments, the method further comprises providing the emergency responder application to the responder device. In some embodiments, the emergency responder application is not provided to the responder device by the RDC.

In some aspects, disclosed herein is non-transitory computer readable storage media comprising instructions that are executable by a processor to perform any of the methods disclosed herein. In some embodiments, the non-transitory computer readable storage media comprises instructions that are executable by a process to perform the method comprising: (a) receiving, from an emergency service provider (ESP), a dispatch request comprising a user identifier; (b) transmitting, to an emergency response data platform (cloud server), an emergency data request comprising the user identifier; (c) receiving, from the cloud server, emergency data comprising an emergency location associated with the user identifier; and (d) transmitting, to an emergency responder application accessed on a responder device, the emergency data comprising the emergency location for display within a graphical user interface (GUI) of the emergency responder application.

In some aspects, disclosed herein is a method for providing emergency response assistance to emergency responders by an emergency response data platform (cloud server), the method comprising: (a) receiving an emergency data request comprising a location of interest from a responder dispatch coordination system (RDC); (b) generating a geospatial boundary around the location of interest; (c) gathering emergency data associated with the locations within the geospatial boundary; and (d) transmitting the emergency data associated with locations within the geospatial boundary to the RDC for transmission to and display within a graphical user interface (GUI) of an emergency responder application. In some embodiments, the size and shape of the geospatial boundary are predetermined by the cloud server. In some embodiments, the size and shape of the geospatial boundary are dynamically determined by the cloud server after receiving the emergency data request. In some embodiments, the size and shape of the geospatial boundary are dynamically determined by the cloud server based at least in part on the location of interest. In some embodiments, the emergency data request is associated with a responder identifier and wherein the size and shape of the geospatial boundary are dynamically determined by the cloud server based at least in part on the responder identifier. In some embodiments, the emergency data request is generated in response to a selection made within the GUI of the emergency responder application. In some embodiments, the size and shape of the geospatial boundary are determined at least in part by a user of the emergency responder application through the GUI of the emergency responder application. In some embodiments, the emergency data request comprises a set of geospatial boundary parameters and wherein the size and shape of the geospatial boundary are determined at least in part on the set of geospatial boundary parameters In some embodiments, the emergency data associated with locations within the geospatial boundary comprises one or more emergency response assets associated with asset locations within the geospatial boundary. In some embodiments, the emergency data associated with locations within the geospatial boundary comprises one or more responder locations within the geospatial boundary. In some embodiments, the emergency data associated with locations within the geospatial boundary comprises one or more responder identifiers associated with the one or more responder locations within the geospatial boundary. In some embodiments, the emergency data associated with locations within the geospatial boundary comprises one or more historical emergency locations within the geospatial boundary. In some embodiments, the emergency data associated with locations within the geospatial boundary comprises one or more user identifiers associated with the one or more historical emergency locations within the geospatial boundary.

In some aspects, disclosed herein is non-transitory computer readable storage media comprising instructions that are executable by a processor to perform any of the methods disclosed herein. In some embodiments, the non-transitory computer readable storage media comprises instructions that are executable by a process to perform the method comprising: (a) receiving an emergency data request comprising a location of interest from a responder dispatch coordination system (RDC); (b) generating a geospatial boundary around the location of interest; (c) gathering emergency data associated with the locations within the geospatial boundary, and (d) transmitting the emergency data associated with locations within the geospatial boundary to the RDC for transmission to and display within a graphical user interface (GUI) of an emergency responder application.

In some aspects, disclosed herein is a system for providing emergency response assistance to emergency responders, the system comprising: (a) an emergency response data platform (cloud server) configured to: (i) receive an emergency alert comprising a user identifier and an emergency location associated with the user identifier; and (ii) transmit, to a responder dispatch coordination system (RDC), the user identifier and the emergency location; and (b) the RDC, configured to: (i) receive, from the cloud server, the user identifier and the emergency location associated with the user identifier; (ii) transmit, to an emergency responder application accessed on a responder device, the user identifier and the emergency location associated with the user identifier for display within a graphical user interface (GUI) of the emergency responder application. In some embodiments, the GUI of the emergency responder application displays a list of dispatch requests and a list of emergency alerts and wherein user identifier is displayed within the list of emergency alerts. In some embodiments, the RDC is further configured to: (a) receive, after receiving the user identifier and the emergency location associated with the user identifier from the cloud server, a dispatch request comprising the user identifier; (b) transmit, to the emergency responder application, the dispatch request for display within the list of dispatch requests within the GUI of the emergency responder application; and (c) prompt the emergency responder application to remove the user identifier from the list of emergency alerts. In some embodiments, the RDC is further configured to provide the emergency responder application to the responder device. In some embodiments, the emergency responder application is not provided to the responder device by the RDC. In some embodiments, the cloud server is further configured to transmit the user identifier and the emergency location associated with the user identifier to the ESP through an emergency response application accessed on a computing device associated with the ESP. In some embodiments, the cloud server is further configured to provide the emergency response application to the ESP. In some embodiments, the emergency response application is a website or a web application accessible via a standard web browser. In some embodiments, the emergency response application is not provided to the ESP by the cloud server. In some embodiments, the emergency response application is a computer aided dispatch (CAD) system.

In some aspects, disclosed herein is a method for transmitting multimedia from a responder device to an emergency service provider (ESP), the method comprising: a) establishing, by a mobile application executed on a responder device, a first communication link with a multimedia capturing device through a wireless access point provided by the multimedia capturing device; b) establishing, by the mobile application, a second communication link with a multimedia processing server associated with an emergency management cloud server through a communication network; c) receiving, by the mobile application, through the first communication link, a stream of multimedia generated by the multimedia capturing device; and d) transmitting, by the mobile application, through the second communication link, the stream of multimedia generated by the multimedia capturing device to the multimedia processing server associated with the cloud server for transmission to an ESP. In some embodiments, the wireless access point provided by the multimedia capturing device does not provide internet access. In some embodiments, the method further comprises establishing, by the mobile application, a third communication link with a channel bonding server associated with the cloud server through the cellular communication network, wherein the channel bonding server manages reception of the stream of multimedia from the multimedia capturing device to the mobile application through the first communication link and the transmission of the stream of multimedia from the mobile application to the multimedia processing server through the second communication link. In some embodiments, the method further comprises establishing, by the mobile application, a virtual private network (VPN) between the responder device and the channel bonding server, wherein the channel bonding server manages the reception of the stream of multimedia from the multimedia capturing device to the mobile application through the first communication link and the transmission of the stream of multimedia from the mobile application to the multimedia processing server through the second communication link through the VPN. In some embodiments, the channel bonding server associated with the cloud server is provided by the cloud server. In some embodiments, the channel bonding server associated with the cloud server is not provided by the cloud server. In some embodiments, the multimedia processing server associated with the cloud server is provided by the cloud server. In some embodiments, the multimedia processing server associated with the cloud server is not provided by the cloud server. In some embodiments, the mobile application receives the stream of multimedia from the multimedia capturing device in response to receiving a selection of a multimedia request prompt from within a graphical user interface (GUI) of the mobile application. In some embodiments, a web link is sent to the user device via a message in response to the selection of the multimedia request prompt for initiating the stream of multimedia from the multimedia capturing device. In some embodiments, the method further comprises receiving, by the mobile application, a multimedia request from the ESP, for instance, on a user device of an emergency responder. In certain approaches, the GUI includes interactive elements for an ESP user to use for one or more of turning on, turning off, muting, blurring, repositioning and zooming the stream of multimedia. In some embodiments, the stream of multimedia is transmitted by the mobile application to the multimedia processing server through a first protocol and transmitted from the multimedia processing server to the ESP through a second protocol. In some embodiments, the first protocol is one of real-time streaming protocol (RTSP) and real-time messaging protocol (RTMP). In some embodiments, the second protocol is one of web real-time communication protocol (WebRTC) and HTTP live streaming protocol (HLS). In some embodiments, the stream of multimedia is transmitted by the multimedia capturing device to the mobile application through a first protocol and transmitted by the mobile application to the multimedia processing server through a second protocol. In some embodiments, the first protocol is RTSP and the second protocol is RTMP. In some embodiments, the stream of multimedia is a one-way flow of audio and video feed. In some embodiments, the stream of multimedia is a two-way flow of audio and video feed.

In some aspects, disclosed herein is a system for transmitting multimedia from a responder device to an emergency service provider (ESP), the system comprising: a) a multimedia capturing device, configured to: provide a wireless access point; generate a stream of multimedia, and transmit the stream of multimedia to a mobile application executed on a responder device; b) the mobile application, executed on the responder device and configured to: establish a first communication link with the multimedia capturing device through the wireless access point; establish a second communication link with a multimedia processing server associated with an emergency response management cloud server through a communication network; receive, through the first communication link, the stream of multimedia from the multimedia capturing device; and transmit, through the second communication link, the stream of multimedia to the multimedia processing server; and c) the multimedia processing server associated with the cloud server, configured to transmit the stream of multimedia to an ESP. In some embodiments, the wireless access point provided by the multimedia capturing device does not provide internet access. In some approaches, the user device is operated by an emergency responder In some approaches, the user device may be operated by a user in an emergency. In some embodiments, the mobile application is further configured to establish a third communication link with a channel bonding server associated with the cloud server through the communication network, wherein the channel bonding server manages reception of the stream of multimedia from the multimedia capturing device to the mobile application through the first communication link and the transmission of the stream of multimedia from the mobile application to the multimedia processing server through the second communication link. In some embodiments, the mobile application is further configured to establish a virtual private network (VPN) between the responder device and the channel bonding server, wherein the channel bonding server manages the reception of the stream of multimedia from the multimedia capturing device to the mobile application through the first communication link and the transmission of the stream of multimedia from the mobile application to the multimedia processing server through the second communication link through the VPN. In some embodiments, the channel bonding server associated with the cloud server is provided by the cloud server. In some embodiments, the channel bonding server associated with the cloud server is not provided by the cloud server. In some embodiments, the multimedia processing server associated with the cloud server is provided by the cloud server. In some embodiments, the multimedia processing server associated with the cloud server is not provided by the cloud server. In some embodiments, the mobile application is further configured to receive the stream of multimedia from the multimedia capturing device in response to receiving a multimedia request from within a graphical user interface (GUI) of the mobile application. In some embodiments, the mobile application is further configured to receive the multimedia request from the ESP. In some embodiments, the mobile application is further configured to transmit the stream of multimedia to the multimedia processing server through a first protocol and wherein the multimedia processing server is further configured to transmit the stream of multimedia to the ESP through a second protocol. In some embodiments, the first protocol is one of real-time streaming protocol (RTSP) and real-time messaging protocol (RTMP). In some embodiments, the second protocol is one of web real-time communication protocol (WebRTC) and HTTP live streaming protocol (HLS). In some embodiments, the multimedia capturing device is further configured to transmit the stream of multimedia to the mobile application through a first protocol and wherein the mobile application is further configured to transmit the stream of multimedia to the multimedia processing server through a second protocol. In some embodiments, the first protocol is RTSP and the second protocol is RTMP. In some embodiments, the user device may prompt an emergency responder or a user in an emergency to provide consent for sharing the stream of multimedia. In some embodiments, the mobile application is further configured to utilize a transcoder software library for one or more tasks such as adjusting bitrate, resolution, and frame rate of the stream of multimedia.

### Emergency Management Cloud Server

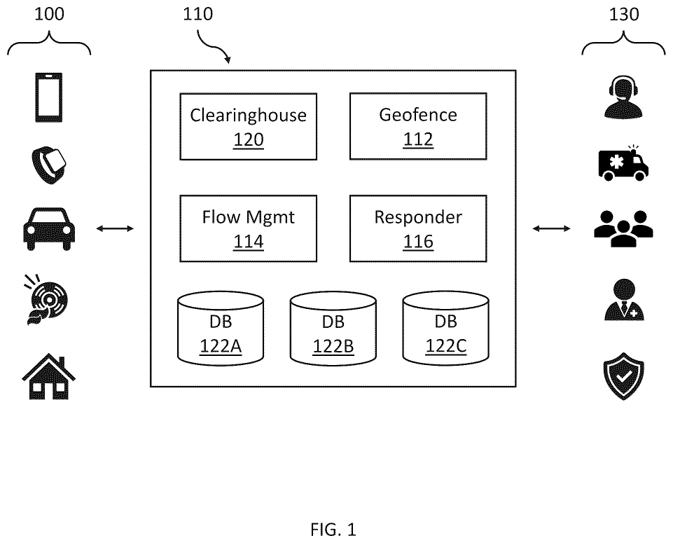

In various embodiments, disclosed herein are devices, systems, and methods for managing emergency data and emergency communications for more effective and efficient emergency response. FIG. 1 depicts a diagram of an emergency management cloud server in accordance with one embodiment of the present disclosure. In a simple example, in some embodiments, an emergency data source 100 transmits emergency to an emergency response data platform (cloud server) 110 before, during, or after an emergency, and the emergency response data platform shares the emergency data with an emergency service provider (ESP) 130. The ESP 130 can then use the emergency data to more efficiently and effectively respond to corresponding emergencies. In some embodiments, the emergency data source 100 is a third-party server system (hereinafter, a first communication link with a multimedia capturing device through a wireless access point provided by the multimedia capturing device “third-party server”). For example, in some embodiments, the emergency data source 100 is a third-party server (e.g., a backend server system) of a technology company that produces software for electronic devices, such as Apple or Google. In some embodiments, the emergency data source 100 is an electronic device. For example, the emergency data source 100 may be a communication device (e.g., a walkie talkie or two-way radio, a mobile or cellular phone, a computer, a laptop, etc.), a wearable device (e.g., a smartwatch), or an Internet of Things (IoT) device such as a home assistant (e.g., an Amazon Echo) or a connected smoke detector (e.g., a Nest Protect smoke and carbon monoxide alarm). In some embodiments, an electronic device includes a display, a processor, a memory (e.g., an EPROM memory, a RAM, or a solid-state memory), a network component (e.g., an antenna and associated components, Wi-Fi adapters, Bluetooth adapters, etc.), a data storage, a user interface, an emergency alert program, one or more location components, and one or more sensors. In some embodiments, the processor is implemented as one or more microprocessors, microcomputers, microcontrollers, digital signal processors, central processing units, state machines, logic circuitries, and/or devices that manipulate signals based on operational instructions. Among other capabilities, the processor is configured to fetch and execute computer-readable instructions stored in the memory.

In some embodiments, the display is part of the user interface (e.g., a touchscreen is both a display and a user interface in that it provides an interface to receive user input or user interactions). In some embodiments, the user interface includes physical buttons such as an on/off button or volume buttons. In some embodiments, the display and/or the user interface comprises a touchscreen (e.g., a capacitive touchscreen), which is capable of displaying information and receiving user input. In some embodiments, the communication device includes various accessories that allow for additional functionality. In some embodiments, these accessories (not shown) include one or more of the following: a microphone, a camera, speaker, a fingerprint scanner, health or environmental sensors, a USB or micro-USB port, a headphone jack, a card reader, a SIM card slot, or any combination thereof. In some embodiments, the one or more sensors include, but are not limited to: a gyroscope, an accelerometer, a thermometer, a heart rate sensor, a barometer, or a hematology analyzer. In some embodiments, the data storage includes a location data cache and a user data cache. In some embodiments, the location data cache is configured to store locations generated by the one or more location components.

In some embodiments, the emergency alert program is a web application or mobile application. In some embodiments, the emergency alert program is configured to record user data, such as a name, address, or medical data of a user associated with the electronic device. In some embodiments, the emergency alert program is configured to detect when an emergency request is generated or sent by the electronic device (e.g., when a user uses the electronic device to make an emergency call) In some embodiments, in response to detecting an emergency request generated or sent by the electronic device, the emergency alert program is configured to deliver a notification to the cloud server 110. In some embodiments, the notification is an HTTP post containing information regarding the emergency request. In some embodiments, the notification includes a location (e.g., a device-based hybrid location) generated by or for the electronic device. In some embodiments, in response to detecting an emergency request generated or sent by the electronic device, the emergency alert program is configured to deliver user data to the cloud server 110.

In some embodiments, the emergency response data platform (cloud server) 110 includes a cloud server operating system, a cloud server CPU, an cloud server memory unit, an EMS communication element, and one or more software modules. In some embodiments, the cloud server CPU is implemented as one or more microprocessors, microcomputers, microcontrollers, digital signal processors, central processing units, state machines, logic circuitries, and/or devices that manipulate signals based on operational instructions. Among other capabilities, the cloud server CPU is configured to fetch and execute computer-readable instructions stored in the cloud server memory unit. The cloud server memory unit optionally includes any computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The cloud server memory unit optionally includes modules, routines, programs, objects, components, data structures, etc., which perform particular tasks or implement particular abstract data types.

In some embodiments, the cloud server 110 includes one or more cloud server databases, one or more servers, and a clearinghouse 120. In some embodiments, the clearinghouse 120, as described in further detail below, is an input/output (I/O) interface configured to manage communications and data transfers to and from the cloud server 110 and external systems and devices. In some embodiments, the clearinghouse 120 includes a variety of software and hardware interfaces, for example, a web interface, a graphical user interface (GUI), and the like. The clearinghouse 120 optionally enables the cloud server 110 to communicate with other computing devices, such as web servers and external data servers. In some embodiments, the clearinghouse 120 facilitates multiple communications within a wide variety of networks and protocol types, including wired networks, for example, LAN, cable, etc., and wireless networks, such as WLAN, cellular, or satellite. In some embodiments, the clearinghouse 120 includes one or more ports for connecting a number of devices to one another or to another server. In some embodiments, the clearinghouse 120 includes one or more sub-clearinghouses, such as location clearinghouse and additional data clearinghouse, configured to manage the transfer of locations and additional data, respectively. In some embodiments, the cloud server 110 additionally includes a user information module that receives and stores user information (e.g., personal information, demographic information, medical information, location information, etc.) within the cloud server 110. In some embodiments, users can submit user information through a website, web application, or mobile application, such as during a registration process for an emergency response application. In some embodiments, when the cloud server 110 receives emergency data including user information, such as through an emergency alert received by the clearinghouse 120 (as described below), the cloud server 110 stores the user information in the user information module. In some embodiments, user information stored within the user information module is received by the cloud server 110 from a third-party server system, as described above. In some embodiments, user information stored within the user information module is associated with an identifier of a user or an electronic device associated with a user, such as a phone number or an email address.

As mentioned above, in some embodiments, the emergency response data platform (cloud server) 110 shares emergency data with an emergency service provider (ESP) 130. In some embodiments, an ESP 130 (e.g., a public safety answering point (PSAP)) is a system that includes one or more of a display, a user interface, at least one central processing unit or processor, a network component, an audio system, (e.g., microphone, speaker and/or a call-taking headset), and an ESP application (e.g., a computer program) such as a computer aided dispatch (CAD) program or an emergency call taking program (also referred to as customer premise equipment or CPE). In some embodiments, the ESP application comprises a database of emergency responders, such as medical assets, police assets, fire response assets, rescue assets, safety assets, etc. In some embodiments, the ESP application is an emergency response application provided by the cloud server 110, as described below. In some embodiments, the ESP application is installed on a computing device at the ESP 130 and comprise one or more software modules, such as a call taking module, an ESP display module, a supplemental or updated information module, or a combination thereof. In some embodiments, the ESP application displays the information on a map (e.g., on the display). In some embodiments, the ESP application is accessible or executable on mobile devices associated with ESP 130, such as emergency responder devices. In some embodiments, the ESP application is an emergency response application provided by the cloud server 110, as described below.

### Emergency Clearinghouse

In some embodiments, as mentioned above with respect to FIG. 1, the emergency response data platform (cloud server) 110 includes a clearinghouse 120 (also referred to as an “Emergency Clearinghouse”) for receiving, storing, retrieving, and transmitting emergency data. In some embodiments, as depicted by FIG. 1, through the clearinghouse 120, the cloud server 110 can receive emergency data from an emergency data source 100 (as described above) and transmit the emergency data to an emergency data recipient, such as an emergency service provider (ESP) 130 (as described above). In this way, the cloud server 110 acts as a data pipeline between emergency data sources 100 and ESPs 130. The emergency data that passes through the clearinghouse 120 may include (but is not limited to) location data (e.g., fixed addresses or device-based hybrid locations generated in real time) and additional data (e.g., medical history, personal information, or contact information, etc.). In some embodiments, through the clearinghouse 120, the cloud server 110 transmits emergency data to ESPs 130 to aid the ESPs 130 in responding to emergencies. For example, location data may allow emergency responders to arrive at the scene of an emergency faster, and additional data may allow emergency responders to be better prepared for the emergencies that they face.

The clearinghouse 120 may receive emergency data in various ways. For example, in some embodiments, an emergency data source 100 can unilaterally transmit emergency data to the clearinghouse 120. For example, in one embodiment, an emergency alert is triggered by an electronic device manually (e.g., in response to the selection of a soft or hard emergency button) or automatically based on sensor data received by the electronic device (e.g., smoke alarms) The electronic device can then transmit the emergency alert and any associated data to the cloud server 110, such as to an endpoint provided by the clearinghouse 120. Or, for example, in one embodiment, after an emergency alert is received by the cloud server 110 from a first emergency data source, the cloud server 110 can query a second emergency data source for emergency data (e.g., emergency data associated with the emergency alert received from the first emergency data source). For example, the emergency alert received from the first emergency data source may include a user identifier (e.g., a telephone number or an email address) for an owner or user of the first emergency data source. The cloud server 110 can then query the second emergency data source with the user identifier to retrieve additional emergency data associated with the owner or user of the first emergency data source. In some embodiments, emergency data received by the cloud server 110 is received in a format that is compatible with industry standards for storing and sharing emergency data. In some embodiments, the cloud server 110 formats emergency data that it receives into a format that is compatible with industry standards. For example, in some embodiments, the emergency data is formatted to be compatible with National Emergency Number Association (NENA) standards. In some embodiments, emergency data is formatted by the cloud server 110 to be compliant with the Presence Information Data Format Location Object (PIDF-LO) standard. In some embodiments, emergency data (or emergency call data, as described below) is formatted by the cloud server to be compliant with the Emergency Incident Data Object (EIDO) standard. In some embodiments, emergency data received by the cloud server 110 is stored within one or more databases 122A, 122B, 122C. In some embodiments, emergency data received by the cloud server 110 is associated with one or more identifiers, such as a device or user identifier.

The clearinghouse 120 may share emergency data in various ways. For example, in some embodiments, an emergency data recipient, such as an ESP 130, can query the cloud server 110 for emergency data. For example, in some embodiments, an ESP 130 can query the cloud server 110 with an emergency data request including a user identifier (e.g., a telephone number or an email address) to receive emergency data gathered or received by the cloud server 110 associated with the user identifier. Or for example, in some embodiments, an ESP 130 can query the cloud server 110 with a geospatial area to receive emergency data gathered or received by the cloud server 110 associated with the geospatial area. Alternatively, in some embodiments, the cloud server 110 can autonomously transmit emergency data to an emergency data recipient without first receiving a query from the emergency data recipient (also referred to as “pushing” emergency data, as opposed to emergency data being “pulled” with a query) In some embodiments, the cloud server 110 pushes emergency data to an emergency data recipient using an emergency data subscription system. Using the emergency data subscription system, an emergency data recipient can subscribe to the clearinghouse 120 for a particular device identifier, user identifier, ESP account, or geospatial area. After subscribing to a subscription, the emergency data recipient may automatically receive updates regarding the subscription without first sending a query for emergency data. For example, if an ESP 130 subscribes to a phone number, whenever the cloud server 110 receives updated emergency data associated with the phone number, the clearinghouse 120 can instantly and automatically transmit the updated emergency data associated with the phone number to the ESP 130.

### Emergency Data Geofencing

In some embodiments, a geofence system 112 is applied to the clearinghouse 120 or the cloud server 110 to protect sensitive emergency data from being shared with unintended recipients. As depicted in FIG. 1, in some embodiments, when emergency data (e.g., an emergency location or additional data) is received by the cloud server 110 from an emergency data source 100, the emergency data is first processed by the geofence system 112 before being ingested by the clearinghouse 120. Similarly, in some embodiments, when a query for emergency data is received by the cloud server 110 from an emergency data recipient (e.g., an ESP 130), the query is processed by the geofence system 112 before emergency data is transmitted to the emergency data recipient.

Generally, a geofence is a virtual perimeter that represents a real-world geographic area. A geofence can be dynamically generated—as in a radius around a point location—or a geofence can be a predefined set of boundaries (such as school zones or neighborhood boundaries). For emergency response, an emergency service provider (public or private entities) may be given jurisdictional authority to a certain geographical region or jurisdiction (also referred to as “authoritative regions”). In the context of emergency services, one or more geofences may correspond to the authoritative region of an ESP. In many cases, the ESP is a public entity such as a public safety answering point (PSAP) or a public safety service (PSS; e.g., a police department, a fire department, a federal disaster management agency, national highway police, etc.), which have jurisdiction over a designated area (sometimes, overlapping areas). Geofences are used to define the jurisdictional authority by various methods and in various Geographic Information System (GIS) formats. In some embodiments, geofences only represent authoritative regions if the geofence has been assigned or verified by a local, state, or federal government. In some embodiments, geofences represent assigned jurisdictions that are not necessarily authoritative regions. For example, in some embodiments, a geofence is unilaterally created by its associated ESP without verification or assignment by a local, state, or federal government.

In some embodiments, the cloud server 110 maintains a geofence database including one or more geofences associated with each ESP 130 that is or has ever been communicatively coupled to the cloud server 110. In some embodiments, a geofence associated with an ESP 130 may be submitted to the cloud server 110 by an administrator of the ESP 130, such as through an emergency response application (as described below) or via email. In some embodiments, when emergency data is received by the cloud server 110 the cloud server 110 identifies a location associated with the emergency data (e.g., an emergency location included in an emergency alert) and determines if the location is within the combined authoritative jurisdiction (i.e., within any one of the geofences stored in the geofence database). In some embodiments, if the location is not within the combined authoritative jurisdiction, the cloud server 110 rejects or drops the emergency data (also referred to as “ingress filtering”). In some embodiments, when the cloud server 110 receives a query for emergency data from an ESP 130, the cloud server 110 identifies a geofence associated with the ESP 130 and returns only emergency data associated with locations that are within the geofence associated with the ESP 130 (also referred to as “egress filtering). In some embodiments, geofences are used in routing emergency data that is pushed to an emergency data recipient. In some embodiments, example, as mentioned above, an emergency data recipient may subscribe to a geofence. Then, when the cloud server 110 receives emergency data associated with a location that is within the geofence to which the emergency data recipient has subscribed, the cloud server 110 can instantly and automatically push the emergency data to the emergency data recipient.

### Emergency Response Application

As mentioned above, in some embodiments, data and information is shared between the emergency response data platform (cloud server) and an emergency service provider (ESP) through an emergency response application. In some embodiments, as described in further detail below, the emergency response application may additionally be provided to an ESP to: a) facilitate communications between the ESP and an emergency caller (e.g., a person requesting emergency assistance) or b) facilitate communications between the ESP and one or more other ESPs. In some embodiments, the emergency response application is a software application either installed on a computing device at the ESP or accessed via the internet through a web browser on the computing device (e.g., the emergency response application is hosted on a cloud computing system by the cloud server). In some embodiments, the emergency response application functions to both facilitate a two-way communication link between the cloud server and the ESP and visualize data (e.g., emergency data) received by the ESP from the cloud server. The emergency response application optionally includes various components, such as a frontend application (hereinafter “graphical user interface” or “GUI”), a backend application, an authorization module, and a user database. In some embodiments, the emergency response application additionally or alternatively includes a credential management system or a geofence system (which may include or be otherwise communicatively coupled to a credentials database or a geofence database). In some embodiments, the credential management system and the geofence system are external to the emergency response application and communicatively coupled to the emergency response application (e.g., the credential management system or geofence system can be housed or hosted on a cloud computing system by the cloud server). Any or all of the components of the emergency response application may be hosted on a cloud computing system by the cloud server, a computing device at an ESP, or some combination thereof.

In some embodiments, the emergency response application is a webpage or web application that can be accessed through an internet or web browser. In such embodiments, the emergency response application can be quickly and easily integrated into the systems used by emergency service providers (ESPs), such as public safety answering points (PSAPs), because accessing and using emergency response application requires no additional software or hardware outside of standard computing devices and networks. As previously discussed, one of the greatest hinderances that PSAPs face in providing emergency assistance to people experiencing emergency situations is in acquiring accurate locations of the emergencies and the people involved, because PSAPs are currently typically limited to verbally asking for and verbally receiving locations from callers. In some embodiments, the clearinghouse is capable of receiving accurate locations (as well as additional emergency data, as described above) from electronic devices such as smartphones and delivering the accurate locations to the appropriate PSAPs during emergency situations. Therefore, it is advantageous to provide the emergency response application to PSAPs in the form of a webpage accessible through a standard web browser, in order to provide the potentially life-saving information stored within the clearinghouse to those capable of providing emergency assistance as quickly and easily as possible. However, in some embodiments, the emergency response application is a software application installed on a computing device at an ESP. The emergency response application may be provided by the cloud server or by a third-party.

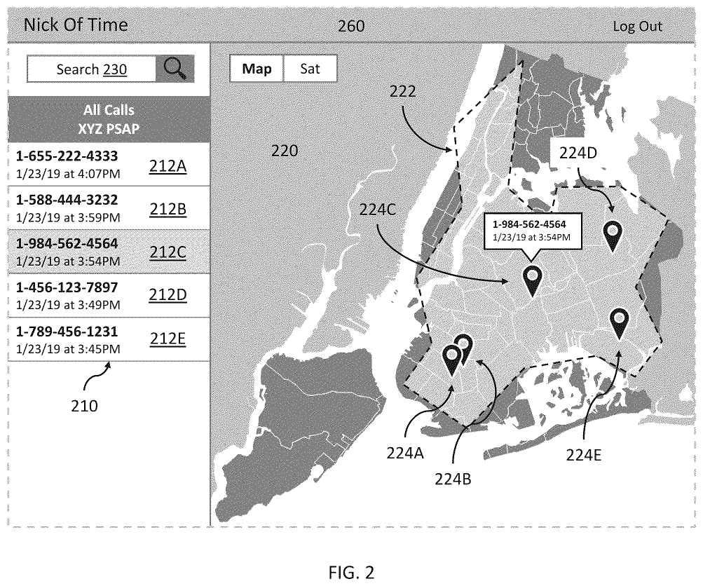

FIG. 2 illustrates an embodiment of a graphical user interface (GUI) provided by an emergency response application 260. In some embodiments, the GUI provides interactive elements that allow a user at an ESP to receive data from the cloud server, visualize data received from the cloud server, and transmit data to the cloud server. For example, in some embodiments, the GUI includes an entry field 230 through which a user can submit a device identifier, such as by typing or pasting the device identifier into the entry field 230. In some embodiments, after submitting a device identifier through the entry field 230, the user can prompt the emergency response application to generate and send an emergency data request by selecting a search button. The emergency response application 260 then generates an emergency data request including the device identifier and any other necessary information (e.g., a temporary access token) and transmits the emergency data request to the cloud server. The cloud server can then return any available emergency data associated with the device identifier to the emergency response application 260, as described above and below. In another example, in some embodiments, the emergency response application 260 can automatically receive emergency data from the cloud server for emergencies relevant to an ESP (e.g., emergencies located within the jurisdiction of the ESP) without requiring a user to generate an emergency data request, as described above and below. After receiving emergency data from the cloud server, the emergency response application 260 can then visualize the emergency data within the GUI of the emergency response application 260. For example, in some embodiments, the emergency response application 260 includes a list of incidents 210 and an interactive map 220, as illustrated by FIG. 2. As shown, in some embodiments, when the emergency response application 260 receives a location (e.g., an emergency location) and a device identifier associated with an emergency occurring within the jurisdiction 222 of the receiving ESP, the emergency response application 260 displays the location associated with the emergency within the interactive map 220 as a location marker 224A, 224B, 224C, 224D, 224E (also referred to as an “incident location”) and displays the device identifier associated with the emergency within the list of incidents 210 as an incident 212A, 212B, 212C, 212D, 212E.

In addition to emergency locations, the emergency response application 260 can receive and visualize numerous types of emergency data from the cloud server. For example, the emergency response application 260 can receive additional data regarding an emergency, such as demographic or medical data associated with a person involved in the emergency (e.g., an emergency caller). In another example, the emergency response application 260 can receive data from sensors associated with the emergency, such as heartrate data collected by a sensor on an emergency caller's smartwatch. Or, for example, the emergency response application 260 can receive data regarding emergency response assets available for an emergency, as described below. In some embodiments, the emergency response application receives and visualizes messages received from emergency callers or other ESPs, as described below. The emergency response application 260 can visualize any emergency data received from the cloud server within the GUI of the emergency response application.

### Emergency Data Transmission

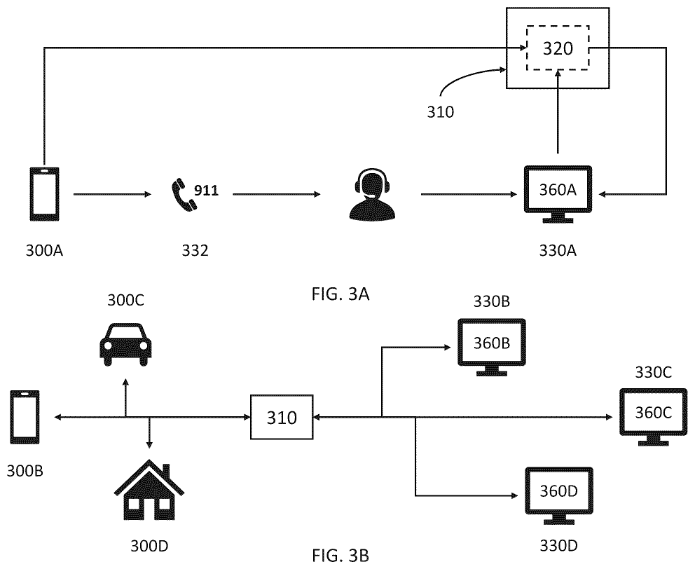

FIGS. 3A and 3B depict systems and processes for receiving and transmitting emergency data by an emergency response data platform in accordance with some embodiments of the present disclosure. As described above, in some embodiments, an emergency response data platform (cloud server) maintains a clearinghouse that obtains and shares emergency data to aid emergency service providers (ESPs) in responding to emergencies. For example, as depicted in FIG. 3A, during an emergency, an ESP 330A can send a query for emergency data (also referred to as an “emergency data request”) to the cloud server 310 (e.g., through an emergency response application 360A, as described above) for a particular emergency, and, in response, the cloud server 310 can send any available emergency data associated with the emergency back to the ESP 330A (such as through emergency response application 360A). In some embodiments, as described above, the emergency response application 360A includes an identifier associated with an emergency alert in the emergency data request. The cloud server 310 can then use the identifier associated with the emergency alert to retrieve emergency data associated with the emergency alert from the clearinghouse 320. For example, as described above, an ESP 330A (e.g., a public safety answering point (PSAP)) can receive an emergency alert in the form of a 9-1-1 phone call 332 (representative of an emergency or potential emergency) from a mobile phone 300A associated with a phone number (e.g., (555) 555-5555). The ESP 330A can then send an emergency data request including the phone number (i.e., the identifier associated with the emergency alert) to the cloud server 310, which can then retrieve any emergency data within the clearinghouse 320 associated with the phone number and return the available emergency data to the requesting ESP 330A. This process of returning emergency data to an ESP in response to an emergency data request is referred to as “pulling” emergency data from the clearinghouse.

As described above, in some embodiments, the emergency response data platform (cloud server) can “push” emergency data from the Emergency Clearinghouse to emergency service providers (ESPs), such as by using an emergency data subscription system (hereinafter, “subscription system”). FIG. 3B depicts a flow diagram of a process for pushing emergency data from the Emergency Clearinghouse to one or more ESPs. In some embodiments, a member of an ESP (e.g., a PSAP staff member) logs into the emergency response application 360B at an ESP system 330B (e.g., a computing device associated with the ESP) by accessing the emergency response application 360B (e.g., by navigating to the emergency response application 360B through a web browser) and submitting their login information through the GUI of the emergency response application 360B. In some embodiments, when the ESP member logs into the emergency response application 360B by submitting their login information, the emergency response application 360B or cloud server 310 then determines an ESP account ID associated with the ESP member's account and establishes a persistent or active communication link (e.g., a websocket connection) with the ESP system 330B, thereby automatically subscribing the ESP console to the ESP account ID for the duration of their login session. Then, as described above, when the cloud server 310 receives an emergency alert including a location (e.g., when an emergency call is made from an electronic device 300B and sends an emergency alert to the cloud server 310 including a location generated by the electronic device 300B), the cloud server 310 retrieves a geofence associated with every ESP registered with the cloud server 310 and determines if the location falls within any of the geofences. In response to determining that the location falls within a geofence associated with the ESP associated with the ESP account ID, the cloud server 310 then associates the location with the ESP account ID, determines if there are any active or persistent communication links between the cloud server 310 and any computing devices subscribed to the ESP account ID. In this instance, because the ESP system 330B is subscribed to the ESP account ID and actively linked to the cloud server 310 through the persistent or active communication link, the cloud server 310 automatically pushes (e.g., from the clearinghouse) the emergency alert or emergency data associated with the emergency alert (e.g., the location, a phone number, etc.) to the ESP system 330B for display within the emergency response application 360B. In some embodiments, emergency alerts or emergency data associated with emergency alerts that have been pushed to an ESP are displayed within a jurisdictional awareness view, as described below.

For example, ESP system 330B and ESP system 330C are two different ESP consoles associated with the same ESP (e.g., two computing devices at the same public safety answering point (PSAP)), PSAP A. ESP system 330D is associated with a second ESP, PSAP B. One day, PSAP call-takers access and successfully log into the emergency response application (emergency response application 360B-360D) at each of the three ESP system (ESP systems 330B-330D), thereby establishing three separate active communication links, one active communication link between the cloud server 310 and each of the three ESP consoles. The ESP consoles are automatically subscribed by the cloud server 310 to the ESP account IDs associated with their respective ESPs (ESP ID A for PSAP A and ESP ID B for PSAP B). Both PSAP A and PSAP B are associated with only one geofence, geofence A and geofence B, respectively. Geofences A and B do not overlap. The geofences have previously been tagged within the cloud server 310 with their respective ESP account IDs (e.g., during a registration process for the emergency response application).

Later that day, an emergency call is made from communication device 300B, which causes communication device 300B to generate a first emergency alert including a first location of the communication device 300B and transmit the first emergency alert to the cloud server 310. When the cloud server 310 receives the first emergency alert, the cloud server 310 retrieves some or all of the geofences stored within the cloud server 310 and determines if the first location falls within any of the geofences stored within the cloud server 310. In this example, the cloud server 310 determines that the first location falls within geofence A, associated with PSAP A. In response, the cloud server 310 tags the first location with the ESP account ID associated with geofence A, ESP ID A. The cloud server 310 then determines if there are any active communication links between the cloud server and any ESP consoles subscribed to ESP ID A and automatically pushes (e.g., from the clearinghouse) the first emergency alert to those ESP consoles. In this example, both ESP system 330B and ESP system 330C are subscribed to ESP ID A, so the cloud server 310 automatically pushes the first emergency alert to both ESP system 330B and ESP system 330C for display within emergency response applications 360B and 360C, respectively, such as through a jurisdictional awareness view (as described below). The first location does not fall within geofence B, because geofence A and geofence B do not overlap, so the first emergency alert is not pushed to ESP system 330D, even though an active communication link has been established between the cloud server 310 and ESP system 330D.

Three minutes later, the cloud server 310 receives an emergency alert from electronic device 300D (e.g., a home security system) including a second location of the electronic device 300D. When the cloud server 310 receives the second emergency alert, the cloud server again retrieves some or all of the geofences stored within the cloud server 310 and determines if the second location falls within any of the geofences stored within the cloud server 310. In this example, the cloud server 310 determines that the second location falls within geofence B, associated with PSAP B. In response, the cloud server 310 tags the second location within the ESP account associated with geofence B, ESP ID B and automatically pushes the second emergency alert to ESP system 330D for display within emergency response application 360D, because ESP system 330D has an active communication link established with the cloud server 310 and ESP system 330D is subscribed to ESP ID B. The cloud server 310 does not push the second emergency alert to ESP system 330B or ESP system 330C. Although ESP system 330B and ESP system 330C have active communication links established with the cloud server 310, they are not subscribed to ESP ID B, and geofence A and geofence B do not overlap, meaning the second location does not fall within geofence A. Two minutes after that, the cloud server 310 receives an emergency alert from electronic device 300C (e.g., an intelligent vehicle system) including a third location of the electronic device 300C. The cloud server 310 determines that the third location falls within geofence A (like the first location included in the first emergency alert) and thus automatically pushes the third emergency alert to both ESP system 330B and ESP system 330C for display within emergency response application 360B and 360C. In some embodiments, emergency response application 360B and emergency response application 360C display the first emergency alert and the third emergency alert simultaneously, such as through a jurisdictional awareness view, as described below.

### Jurisdictional Awareness View

In some embodiments, the systems, applications, servers, devices, methods, and media of the instant application provide a jurisdictional awareness view within the emergency response application. In some embodiments, the jurisdictional awareness view enables an ESP to view one or more ongoing or recently received emergency alerts (e.g., emergency calls) within one or more geofenced jurisdictions. FIG. 2 illustrates the jurisdictional awareness view displayed within the emergency response application, in accordance with one embodiment of the present disclosure. In some embodiments, the jurisdictional awareness view includes a list of incidents 210 that displays one or more incidents 212A, 212B, 212C, 212D, 212E associated with one or more device identifiers (e.g., phone numbers, IP addresses). In some embodiments, the jurisdictional awareness view additionally or alternatively includes an interactive map 220 that displays one or more incident locations 224A, 224B, 224C, 224D, 224E associated with the one or more incidents 212A, 212B, 212C, 212D, 212E associated with the one or more device identifiers, as described below. In some embodiments, the jurisdictional awareness view displays incidents and incident locations only for emergencies occurring within the jurisdiction 222 of the ESP at which the emergency response application 260 is being accessed.

For example, in the example illustrated in FIG. 2, an ESP has accessed an emergency response application 260 provided by the cloud server. In this example, the cloud server has pushed emergency data associated with five different emergency alerts to the ESP (as described above) through the emergency response application 260. Accordingly, the emergency response application 260 displays five different incidents (e.g., incidents 212A-212E) within the list of incidents 210 and five corresponding incident locations (e.g., incident locations 224A-224E) within the interactive map 220. As illustrated by FIG. 2, in some embodiments, incidents 212A, 212B, 212C, 212D, 212E and incident locations 224A, 224B, 224C, 224D, 224E may be selected or hovered over to highlight a particular incident. In this example, incident 212C and its corresponding incident location 224C have been selected and highlighted. In some embodiments, selecting a particular incident (e.g., 212C) or corresponding incident location (e.g., 224C) prompts the emergency response application 260 to display additional information associated with the particular incident (e.g., additional emergency data or information associated with the emergency alert for which the particular incident (e.g., 212C) was created). Because the jurisdictional awareness view can show an ESP numerous incidents 212A, 212B, 212C, 212D, 212E occurring within the jurisdiction 222 of the ESP simultaneously, the jurisdictional awareness view can provide the ESP with situational awareness that the ESP otherwise would not have. For example, with the knowledge that incidents 212A and 212B originated in close proximity and at approximately the same time, an ESP personnel (e.g., a call taker at a public safety answering point) can determine that the two incidents may be related.

### Responder Dispatch Coordination System

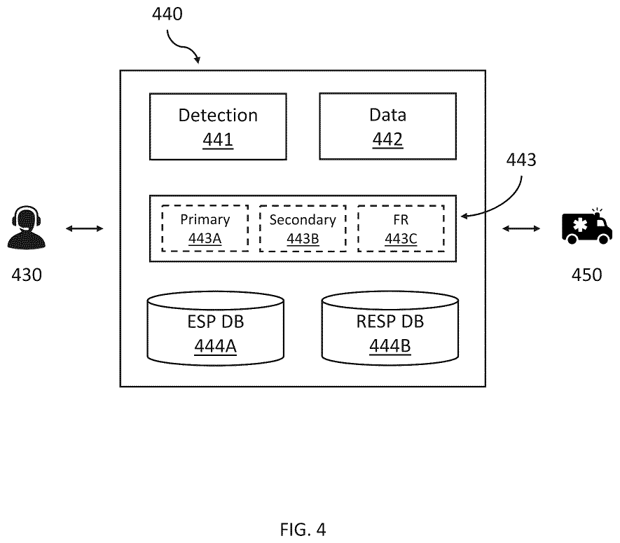

As mentioned above, in various embodiments, disclosed herein is a responder dispatch coordination system that facilitates communications between emergency service providers (ESPs; e.g., primary and secondary ESPs, as described below) and emergency responders to aid emergency response networks and systems in responding to emergencies. FIG. 4 depicts an exemplary embodiment of a responder dispatch coordination system (RDC). In some embodiments, as depicted in FIG. 4, an RDC 440 is a computing system (e.g., hardware, software, or a combination thereof) that includes one or more modules, such as a dispatch request detection module 441, a responder data management module 442, and an RDC application module 443. In some embodiments, the dispatch request detection module 441 functions to detect dispatch requests generated by ESPs (e.g., primary ESPs) and ingest the dispatch requests into the RDC 440, as described below. In some embodiments, the responder data management module 442 functions to manage the receipt of emergency responder data from emergency responders 450 and the transmission of emergency responder data to ESPs 430 (e.g., primary and secondary ESPs). In some embodiments, the RDC application module 443 functions to provide ESPs 430 (e.g., primary and secondary ESPs) and emergency responders 450 with graphical user interfaces (GUIs) for interfacing with data and functions provided to the ESPs 430 and emergency responders 450 by the RDC 440. In some embodiments, as depicted in FIG. 4, the RDC application module 443 provides RDC applications in different forms, such as a primary ESP application 443A, a secondary ESP application 443B, and an emergency responder application 443C, as described below. In some embodiments, as depicted in FIG. 4, an RDC 440 includes one or more databases 444A, 444B, such as an ESP database 444A and a responder database 444B. In general, as described in further detail below, the modules of the RDC function together to receive dispatch requests from primary ESPs, forward dispatch requests to emergency responders, receive data regarding emergency responders (whether or not those emergency responders are the recipients of forwarded dispatch requests), and share data regarding emergency responders with primary and secondary ESPs.

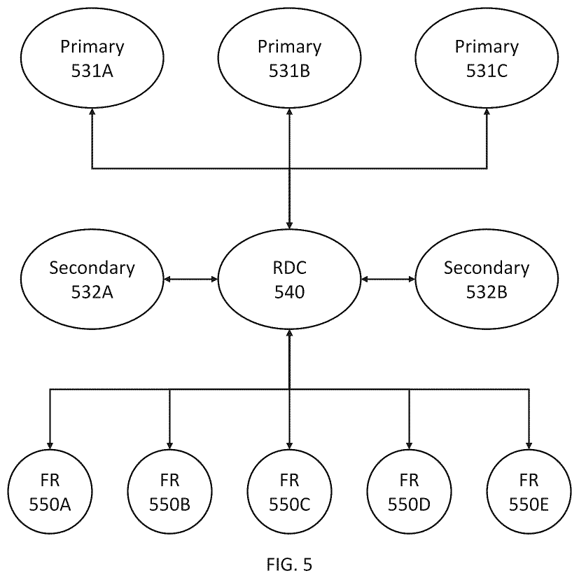

FIG. 5 depicts a diagram of a responder dispatch coordination system (RDC) communicatively coupled to one or more primary emergency service providers (hereinafter, “primary ESPs”), one or more secondary emergency service providers (hereinafter, “secondary ESPs”), and one or more emergency responders. In some embodiments, an RDC 540 is communicatively coupled only to one or more emergency responders 550A, 550B, 550C, 550D, 550E. In some embodiments, an RDC 540 is communicatively coupled only to one or more emergency responders 550A, 550B, 550C, 550D, 550E and one or more secondary ESPs 532A, 532B. In general, a primary ESP 531A, 531B, 531C (e.g., a public safety answering point, or “PSAP”) is an ESP that functions primarily to receive primary requests for emergency service (e.g., emergency calls, such as 9-1-1 phone calls in the United States) and transmit dispatch requests to secondary ESPs 532A, 532B and emergency responders 550A, 550B, 550C, 550D, 550E. In general, a secondary ESP 532A, 532B (e.g., a fire department, a police department, or an emergency medical service) is an ESP that functions primarily to manage the dispatching and coordination of emergency responders 550A, 550B, 550C, 550D, 550E. In some embodiments, primary ESPs and secondary ESPs are separate and distinct organizations. In some embodiments, a single ESP may perform the functions of both a primary ESP 531A, 531B, 531C and a secondary ESP 532A, 532B. In some embodiments, primary ESPs 531A, 531B, 531C and secondary ESPs 532A, 532B have particular relationships, which may be based on various factors, such as geographic location, emergency type, or time and date. For example, primary ESP 531A may be a PSAP in the city of Syracuse, New York, secondary ESP 532A may be a fire department in Syracuse that the PSAP transmits dispatch requests to when the PSAP receives primary requests for emergency service (e.g., emergency calls) regarding fire emergencies, and secondary ESP 532B may be an emergency medical service in Syracuse that the PSAP transmits dispatch requests to when the PSAP receives primary requests for emergency service (e.g., emergency calls) regarding medical emergencies. In general, an emergency responder 550A, 550B, 550C, 550D, 550E (e.g., a firefighter, a police officer, or an emergency medical technician) is a person who responds to emergencies. In some embodiments, an emergency responder 550A, 550B, 550C, 550D, 550E is associated with a particular secondary ESP 532A, 532B. For example, secondary ESP 532A may be a fire department, and emergency responders 550A and 550B are firefighters employed by the fire department; while secondary ESP 532B is a police department, and emergency responders 550C and 550D are police officers employed by the police department. In some embodiments, an emergency responder 550A, 550B, 550C, 550D, 550E is not associated with a particular secondary ESP 532A, 532B. For example, emergency responder 550E may be a volunteer emergency medical technician (EMT) that is not employed by any emergency medical service.

### Dispatch Request Detection

As mentioned above, in general, a responder dispatch coordination system (RDC) functions to receive dispatch requests from primary ESPs, forward dispatch requests to emergency responders, receive data regarding emergency responders, and share data regarding emergency responders with primary and secondary ESPs. The RDC may receive a dispatch request from a primary ESP in various ways. In some embodiments, the RDC receives a dispatch request from a primary ESP directly. For example, in some embodiments, the RDC provides an application programming interface (API) that can be integrated into a software application employed by a primary ESP (e.g., a computer aided dispatch system, or “CAD” system), such that when the primary ESP generates a dispatch request within their software application, the dispatch request can be automatically or optionally transmitted directly to the RDC through the API integrated into the software application. Or for example, in some embodiments, the RDC provides one or more email addresses to a primary ESP (hereinafter, “dispatch email addresses”), with which the primary ESP can email dispatch requests directly to the RDC. In some such embodiments, like the API in the previous example, the one or more email addresses can be integrated into a software application employed by a primary ESP (e.g., a CAD system), such that when the primary ESP generates a dispatch request within their software application, the dispatch request can be automatically or optionally emailed directly to the RDC through the one or more email addresses integrated into the software application. In some embodiments, the RDC provides a primary ESP with different dispatch email addresses for different secondary ESPs associated with the primary ESP. The RDC can then determine which secondary ESP to associate a dispatch request with based on the dispatch email address to which the dispatch request was sent. For example, if PSAP A (e.g., a primary ESP) is associated with Fire Department 1 and Police Department 1 (e.g., two secondary ESPs), the RDC can provide PSAP A with a first dispatch email address for Fire Department 1 and a second dispatch email address for Police Department 1. If PSAP A sends a dispatch request to the first dispatch email address, the RDC can simultaneously receive the dispatch request and associate the dispatch request with Fire Department 1. If PSAP A sends a dispatch request to the second dispatch email address, the RDC can simultaneously receive the dispatch request and associate the dispatch request with Police Department 1.

In some embodiments, the RDC receives a dispatch request from a primary ESP indirectly. For example, in some embodiments, the RDC provides or is otherwise communicatively coupled to a radio dispatch monitoring system capable of detecting a dispatch request made by a primary ESP over a radio signal. In many instances, especially in smaller jurisdictions, a primary ESP (e.g., a PSAP) will transmit a dispatch request (e.g., a voice-based dispatch request) to a secondary ESP (e.g., a fire department or a police department) over a radio signal. For example, every secondary ESP that a primary ESP communicates with may be given or otherwise associated with a different radio frequency to listen to at any or all times, such that when the primary ESP transmits a dispatch request to a radio frequency associated with a particular secondary ESP, the particular secondary ESP, and only the particular secondary ESP, will receive the dispatch request. In some embodiments, a radio dispatch monitoring system provided by or otherwise communicatively coupled to the RDC is configured to intercept a dispatch request made by a primary ESP over a radio signal. For example, in some embodiments, the radio dispatch monitoring system is a hardware device associated with a secondary ESP and configured to constantly monitor a radio frequency given to or otherwise associated with the secondary ESP. When a primary ESP transmits a dispatch request over the radio frequency associated with the secondary ESP, the radio dispatch monitoring system detects the dispatch request and transmits an electronic communication regarding the dispatch request to the RDC. In some embodiments, when the radio dispatch monitoring system detects a dispatch request made by a primary ESP over a radio signal, the radio dispatch monitoring system employs a natural language processing module to transcribe the dispatch request, and the transcription of the dispatch request is included in the electronic communication regarding the dispatch request transmitted to the RDC. In some embodiments, when the dispatch monitoring unit detects a dispatch request made by a primary ESP over a radio signal, the radio dispatch monitoring system records the dispatch request into an audio file, and the audio file recording is included in the electronic communication regarding the dispatch request transmitted to the RDC.

In some embodiments, after the RDC detects or otherwise receives a dispatch request made by a primary ESP, the RDC parses the dispatch request for dispatch data. For example, in some embodiments, when the RDC receives a dispatch request in the form of an email (as described above), the RDC parses the contents of the email (e.g., the subject and body of the email) for user or device identifiers (e.g., a name, phone number, or email address associated with the emergency for which the dispatch request was generated) locations, or descriptions associated with the emergency that the dispatch request was made for. Or for example, in some embodiments, when the RDC receives a dispatch request made over a radio signal and transcribes the dispatch request (as described above), the RDC parses the transcription of the dispatch request for names, locations, or descriptions associated with the emergency that the dispatch request was made for.

### Dispatch Request Transmission

In some embodiments, after detecting a dispatch request made by a primary ESP (as described above), the RDC determines one or more emergency responders to forward or transmit the dispatch request (or a notification regarding the dispatch request, also referred to as a “dispatch notification”) to. The RDC can determine one or more emergency responders to forward or transmit the dispatch request to in various ways. In some embodiments, the RDC determines one or more emergency responders to forward or transmit a dispatch request to based at least in part on a location associated with the dispatch request. For example, in some embodiments, if the RDC receives a dispatch request in the form of an email and extracts a location associated with the emergency for which the dispatch request was made (i.e., an emergency location) from the contents of the email, the RDC can use the location to determine one or more emergency responders to forward or transmit the dispatch request to. Or for example, in some embodiments, when the RDC receives a dispatch request from a primary ESP, the RDC can use a location associated with the primary ESP (e.g., the physical address of the primary ESP) to determine one or more emergency responders to forward or transmit the dispatch request to. In some embodiments, the RDC receives real-time locations of emergency responders (e.g., through an emergency responder application provided to the emergency responders by the RDC). In such an embodiment, the RDC can use a location associated with a dispatch request and real-time locations of emergency responders to determine one or more emergency responders to forward or transmit the dispatch request to. For example, in some embodiments, the RDC forwards or transmits a dispatch request to emergency responders who have a real-time location within a predetermined radius of a location associated with dispatch request. In some embodiments, the RDC associates different geographic areas of responsibility (hereinafter, “coverage areas”) with different emergency responders. In such an embodiment, the RDC can use a location associated with a dispatch request and coverage areas associated with emergency responders to determine one or more emergency responders to forward or transmit the dispatch request to. For example, in some embodiments, the RDC forwards or transmits a dispatch request to emergency responders who have a coverage area that a location associated with the dispatch request falls within.

In some embodiments, the RDC determines one or more emergency responders to forward or transmit a dispatch request to based on emergency responders' associations with secondary ESPs. As described above, in some embodiments, a primary ESP is associated with one or more secondary ESPs, and the RDC provides different dispatch email addresses to the primary ESP for each secondary ESP that the primary ESP is associated with. As described above, in some embodiments, emergency responders are associated with secondary ESPs. In such an embodiment, if the RDC can associate a dispatch request with a secondary ESP, the RDC can forward or transmit the dispatch request to one or more emergency responders associated with the secondary ESP. For example, if a primary ESP sends a dispatch request in the form of an email to a dispatch email address associated with a secondary ESP (as described above), the RDC can forward or transmit the dispatch request to one or more emergency responders associated with the secondary ESP. Or for example, if a primary ESP makes a dispatch request over a radio frequency (as described above), and a radio dispatch monitoring system associated with a secondary ESP detects the dispatch request and transmits an electronic communication regarding the dispatch request to the RDC (as described above), the RDC can forward or transmit the dispatch request to one or more emergency responders associated with the secondary ESP. However, the RDC may determine or more emergency responders to forward or transmit the dispatch request to in any other way.

Once the RDC has detected a dispatch request made by a primary ESP (e.g., by receiving the dispatch request directly or indirectly, as described above) and determined one or more emergency responders to forward or transmit the dispatch request to, the RDC can forward or transmit the dispatch request to the one or more emergency responders. As mentioned above, in one aspect, the RDC functions to receive dispatch requests from primary ESPs and transmit dispatch requests to emergency responders. As described above, the RDC can receive dispatch requests from primary ESPs in various ways. Similarly, in some embodiments, the RDC can transmit dispatch requests to emergency responders in various ways. For example, in some embodiments, the RDC can transmit a dispatch request to an emergency responder in the form of a text message. Or for example, the RDC can transmit a dispatch request to an emergency responder in the form of an email. Or for example, in some embodiments, the RDC can transmit a dispatch request to an emergency responder through an emergency responder application (e.g., in the form of a push notification from the emergency responder application), as described below. In some embodiments, the RDC can transmit a single dispatch request to an emergency responder in multiple ways. For example, in some embodiments, the RDC can transmit a single dispatch request to an emergency responder both in the form of a text message and in the form of an email. Or for example, in some embodiments, the RDC can transmit a single dispatch request to an emergency responder in the form of a text message, in the form of an email, and in the form of a push notification through an emergency responder application. Transmitting a dispatch request to an emergency responder in multiple ways provides redundancy that can help ensure that the emergency responder successfully receives the dispatch request. In some embodiments, an emergency responder can choose (e.g., through the emergency responder application) which ways the emergency responder would like to receive a dispatch request from the RDC. In some embodiments, a dispatch request forwarded or transmitted to an emergency responder, in any form, includes a link to an emergency responder application wherein information regarding the dispatch request is displayed, as described below.

### Emergency Responder Application

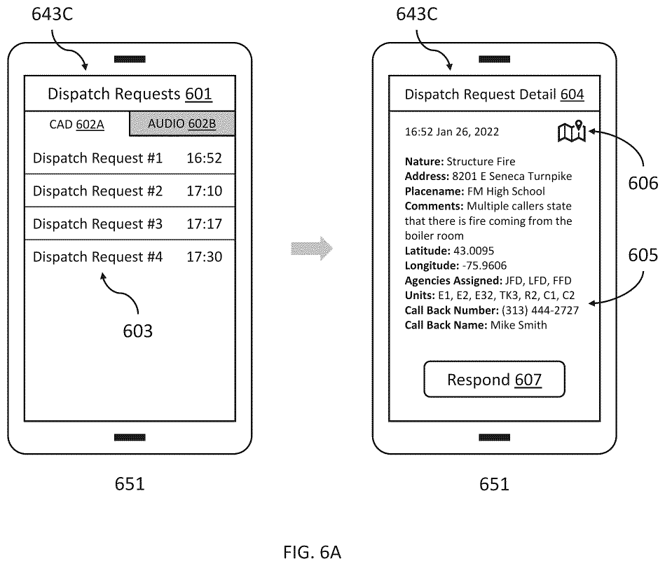

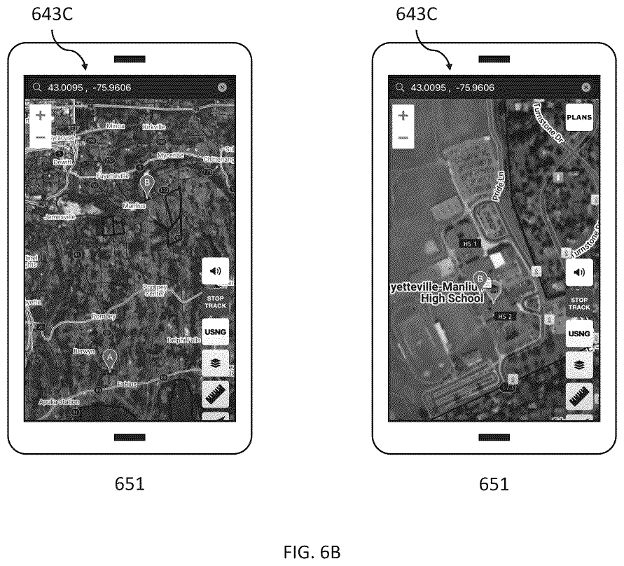

As mentioned above, in some embodiments, the RDC can forward or transmit a dispatch request to an emergency responder through an emergency responder application. FIGS. 6A and 6B illustrate an exemplary embodiment of an emergency responder application provided by the RDC. In some embodiments, as depicted in FIGS. 6A and 6B, the RDC provides emergency responders with an emergency responder application 643C that can be executed on an electronic device (e.g., a mobile phone or a tablet). In some embodiments, the emergency responder application 643C is provided by the RDC in the form of a website or a web application that can be accessed through a standard web browser. In some embodiments, the emergency responder application 643C is provided by the RDC in the form of an application that can or must be downloaded onto an electronic device. In some embodiments, when the emergency responder application 643C is first accessed by an emergency responder, the emergency responder must sign into the emergency responder application 643C (e.g., by entering a username or email address and password) or sign up for the emergency responder application 643C (e.g., by completing a registration process) if the emergency responder has not yet done so. In some embodiments, when signing up for the emergency responder application 643C, an emergency responder must submit i) identification information, such as the emergency responder's name, age, or qualifications; ii) contact information, such as the emergency responder's email address or phone number; or iii) one or more secondary ESPs that the emergency responder is associated with (e.g., a secondary ESP at which the emergency responder is employed, as described above).

In general, the emergency responder application 643C functions to receive dispatch requests and information regarding dispatch requests from the RDC, display dispatch requests and information regarding dispatch requests within a graphical user interface (GUI) of the emergency responder application 643C, receive information regarding emergency responders (hereinafter, “responder data”), and transmit responder data to the RDC. In some embodiments, as illustrated in FIG. 6A, the GUI of the emergency responder application 643C includes a dispatch requests screen 601 that displays a list of dispatch requests 603. In some embodiments, as illustrated in FIG. 6A, the dispatch requests screen 601 includes one or more dispatch request category sections or tabs 602A. 602B. For example, in the example illustrated by FIG. 6A, the dispatch requests screen 601 includes a first dispatch request category tab 602A for dispatch requests received by the RDC that were generated by or sent from CAD systems (as described above) and a second dispatch request category tab 602B for dispatch requests received by the RDC that were made over a radio frequency (as described above). In the example illustrated by FIG. 6A, the RDC has forwarded or transmitted four dispatch requests (i.e., dispatch requests #1-4) that were generated by or sent from CAD systems to an emergency responder accessing the emergency responder application 643C on their emergency responder device 651. These four dispatch requests are now displayed within the GUI of the emergency responder application 643C under the first dispatch request category tab 602A for dispatch requests generated by or sent from CAD systems.

In some embodiments, as illustrated by FIG. 6A, an emergency responder can select a dispatch request from the list of dispatch requests 603 to be shown a dispatch request detail screen 604 that displays information regarding the dispatch request (hereinafter, “dispatch data”). For example, in the example illustrated by FIG. 6A, the emergency responder accessing the emergency responder application 643C has selected dispatch request #1 from the dispatch requests screen 601 and is now shown a dispatch request detail screen 604 that displays dispatch data 605 associated with dispatch request #1. In this example, the dispatch data 605 associated with dispatch request #1 includes the day and time that dispatch request #1 was detected or received by the RDC, the nature of the emergency for which dispatch request #1 was made, a location associated with the dispatch request #1, a placename for the location associated with dispatch request #1, comments associated with dispatch request #1, a longitude and latitude coordinate pair for the location associated with dispatch request #1, a list of secondary ESPs that dispatch request #1 was transmitted to, a list of emergency responders identified as responding to dispatch request #1 (as described below), and a call back name and phone number associated with dispatch request #1 (e.g., the name and phone number of an emergency caller for which dispatch request #1 was made). In the example illustrated by FIG. 6A, from dispatch request #1, the RDC was able to extract dispatch data 605 indicating that dispatch request #1 was made for a structure fire at FM High School, 8201 E Seneca Turnpike. Dispatch data 605 further indicates that the structure fire was reported by a Mike Smith whose phone number is (313) 444-2727, and that three secondary ESPs (e.g., JFD, LFD, and FFD) have been assigned to or otherwise associated with dispatch request #1. In some embodiments, an emergency responder can identify themselves as responding to a dispatch request by selecting a respond button 607 within the GUI of the emergency responder application 643C. For example, in the example illustrated by FIG. 6A, the dispatch request detail screen 604 displayed for a selected dispatch request includes a respond button 607 that an emergency responder can select to identify themselves as responding to the selected dispatch request. However, a respond button may be included on any screen within the GUI of the emergency responder application 643C. In some embodiments, when an emergency responder identifies themselves as responding to a dispatch request (e.g., by selecting a respond button within the GUI of an emergency responder application, as described above), a notification is transmitted to a primary or secondary ESP (e.g., through a primary ESP application or a secondary ESP application, as described below). In some such embodiments, the primary or secondary ESP can respond to the notification to approve or deny the emergency responder's response to the dispatch request, as described below. In some embodiments, as illustrated by FIG. 6A, the dispatch request detail screen 604 displayed for a selected dispatch request includes a map button 606 that an emergency responder can select to be shown a location associated with selected dispatch request within a map, as described below.

As mentioned above, in some embodiments, the emergency responder application 643C can display a location associated with a dispatch request within a map. FIG. 6B illustrates an exemplary embodiment of a map displayed within the GUI of the emergency responder application 643C. In some embodiments, as illustrated by FIG. 6B, the emergency responder application 643C displays a location associated with a dispatch request (in this example, location B) and a location associated with the emergency responder accessing the emergency responder application 643C (in this example, location C) within the map displayed within the GUI of the emergency responder application 643C. In some embodiments, as illustrated by FIG. 6B, the emergency responder application displays directions (e.g., driving directions) from the location associated with the emergency responder and the location associated with the dispatch request. In some embodiments, as illustrated by FIG. 6B, the emergency responder application 643C displays locations of other emergency response resources, such as the locations of ESPs or fire hydrants within the map displayed within the GUI of the emergency responder application 643C.

### Secondary ESP Application

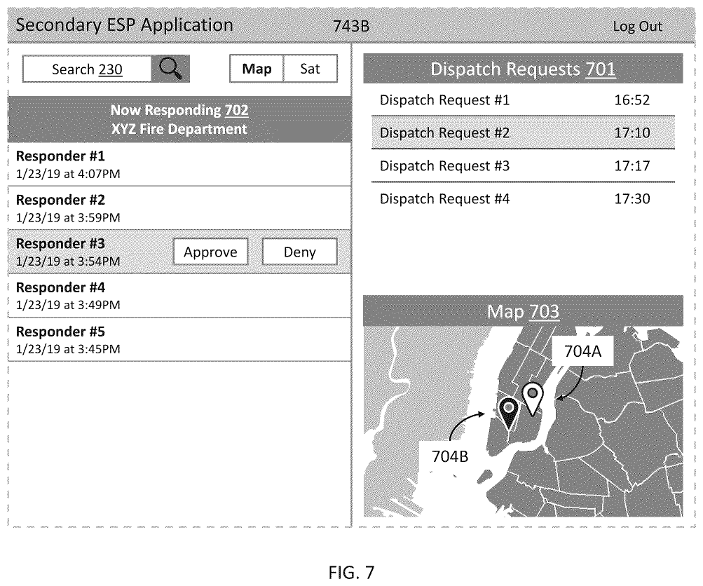

As mentioned above, in some embodiments, the RDC provides secondary ESPs with a secondary ESP application through which secondary ESPs can receive information regarding dispatch requests and emergency responders. FIG. 7 illustrates an exemplary embodiment of a GUI of a secondary ESP application. In some embodiments, as illustrated by FIG. 7, the GUI of the secondary ESP application 743B includes a list of dispatch requests 701 associated with the secondary ESP accessing the secondary ESP application 743B (in this example, XYZ Fire Department). A dispatch request detected or received by the RDC can be associated with a secondary ESP in various ways. For example, in some embodiments, as described above, when a primary ESP transmits a dispatch request to the RDC in the form of an email, the primary ESP transmits the dispatch request to a dispatch email address associated with a particular secondary ESP. The RDC can then associate the dispatch request with the particular secondary ESP based on the dispatch email address. Or for example, in some embodiments, as described above, when a radio dispatch monitoring system installed at or otherwise associated with a particular secondary ESP detects a dispatch request made by a primary ESP over a radio frequency and transmits an electronic communication regarding the dispatch request to the RDC, the RDC can associate the dispatch request with the particular secondary ESP based on the particular secondary ESP's association with the radio dispatch monitoring system. In some embodiments, a secondary ESP is associated with a dispatch request based on a location associated with the dispatch request. For example, in some embodiments, a secondary ESP is associated with one or more geofences (as described above). In such an embodiment, when the RDC detects or receives a dispatch request and determines a location associated with the dispatch request, the RDC can determine if the location associated with the dispatch request falls within a geofence associated with the secondary ESP. If so, the RDC can associate the dispatch request with the secondary ESP. In some embodiments, the RDC can associate a dispatch request with a secondary ESP based on the secondary ESP's association with an emergency responder. For example, if an emergency responder identifies as responding to a dispatch request (such as through the emergency responder application, as described above), and the emergency responder is associated with a secondary ESP (as described above), the RDC can associate the dispatch request with the secondary ESP based on the shared association with the emergency responder. However, the RDC can associate a dispatch request with a secondary ESP in any other way.

In some embodiments, as illustrated by FIG. 7, the GUI of the secondary ESP application 743B includes a list of dispatched emergency responders 702 associated with the secondary ESP. An emergency responder can be associated with a secondary ESP in various ways. For example, in some embodiments, as described above, an emergency responder can submit to the RDC one or more secondary ESPs that the emergency responder is associated with through the emergency responder application Or for example, in some embodiments, if an emergency responder identifies themselves as responding to a dispatch request that is associated with a particular secondary ESP, the RDC can associate the emergency responder (e.g., temporarily associate) with the secondary ESP based on the shared association with the dispatch request. In some embodiments, the RDC can associate an emergency responder with a secondary ESP based on location. For example, in some embodiments, a secondary ESP is associated with one or more geofences (as described above). If the RDC receives a location associated with an emergency responder (e.g., through the emergency responder application, which may be able to receive or determine the location of the emergency responder from the emergency responder device through which the emergency responder is accessing the emergency responder application), the RDC can determine if the location associated with the emergency responder falls within a geofence associated with the secondary ESP. If so, the RDC can associate the emergency responder with the secondary ESP. However, the RDC can associate an emergency responder with a secondary ESP in any other way. In some embodiments, the list of dispatched emergency responders 702 displays emergency responders who have identified themselves as responding to a dispatch request associated with the secondary ESP accessing the secondary ESP application 743B. In some embodiments, the list of dispatched emergency responders 702 displays emergency responders who both a) are associated with the secondary ESP accessing the secondary ESP application 743B and b) have identified themselves as responding to a dispatch request.

In some embodiments, as illustrated by FIG. 7, the GUI of the secondary ESP application 743B includes a map 703. In some embodiments, the map 703 displays locations 704A, 704B associated with dispatch requests associated with the secondary ESP accessing the secondary ESP application 743B. For example, in the example illustrated by FIG. 7, the map 703 displays a location 704A associated with dispatch request #2, which has been selected within the list of dispatch requests 701. In some embodiments, the map 703 displays a location associated with each of the dispatch requests in the list of dispatch requests 701 associated with the secondary ESP accessing the secondary ESP application 743B simultaneously. In some embodiments, the map 703 displays only a location associated with the dispatch request selected within the list of dispatch requests 701. In some embodiments, the map 703 displays locations associated with emergency responders. For example, in the example illustrated by FIG. 7, the map 703 displays a location associated with responder #3, who has been selected within the list of dispatched emergency responders 702. In some embodiments, the map 703 displays a location associated with each of the emergency responders in the list of dispatched emergency responders 702 simultaneously. In some embodiments, the map 703 displays only a location associated with the emergency responder selected within the list of dispatched emergency responders 702. In some embodiments, as illustrated by FIG. 7, the map 703 displays one or more locations associated with dispatch requests and one or more locations associated with emergency responders simultaneously. In some embodiments, as illustrated by FIG. 7, locations associated with dispatch requests and locations associated with emergency responders are displayed within the map 703 in different shapes or colors.

In some embodiments, a user of the secondary ESP application 743B (e.g., a secondary ESP administrator, such as a fire department chief) can use the secondary ESP application 743B to approve or deny an emergency responder's response to a dispatch request. For example, in some embodiments, as illustrated by FIG. 7, a user of the secondary ESP application 743B can select an emergency responder from the list of dispatched emergency responders 702 and select an approve button to approve the emergency responder's response to a dispatch request or select a deny button to deny the emergency responder's response to a dispatch request. Or for example, in some embodiments, when an emergency responder identifies themselves as responding to a dispatch request (as described above), a notification is sent to a secondary ESP associated with the emergency responder or the dispatch request (as described above) through the secondary ESP application 743B. In some embodiments, a user of the secondary ESP application 743B can respond to the electronic notification by selecting an approve button or a deny button to approve or deny the emergency responder's response to the dispatch request. In some embodiments, when a user of the secondary ESP application approves or denies an emergency responder's response to a dispatch request, a notification is transmitted to the emergency responder (e.g., as a push notification from an emergency responder application, or in the form or an email or text message) notifying the emergency responder of the secondary ESP's approval or denial.

### Primary ESP Application

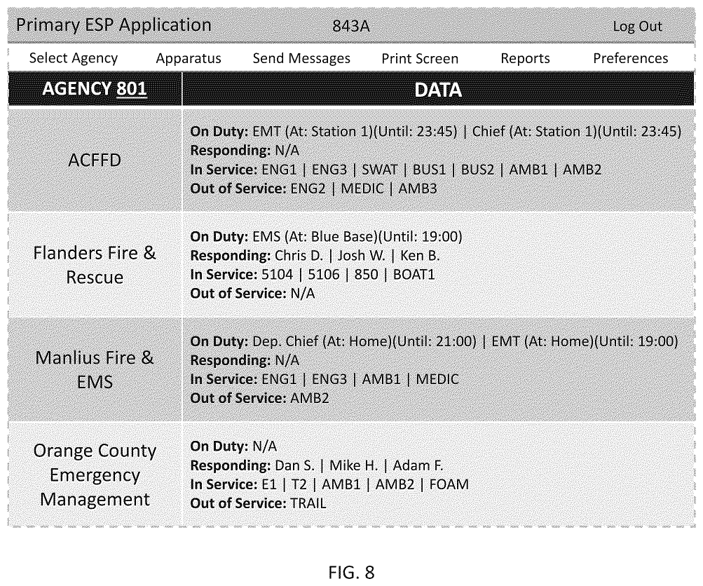

As mentioned above, in some embodiments, the RDC provides primary ESPs with a primary ESP application through which primary ESPs can receive information regarding emergency responders and secondary ESPs. FIG. 8 illustrates an exemplary embodiment of a GUI of a primary ESP application. In some embodiments, as illustrated by FIG. 8, the GUI of the primary ESP application 843A includes a list of secondary ESPs 801 that the primary ESP accessing the primary ESP application is associated with (as described above). For example, in the example illustrated by FIG. 8, the primary ESP application 843A displays four secondary ESPs within the list of secondary ESPs 801 associated with the primary ESP accessing the primary ESP application 843A: ACFFD, Flanders Fire & Rescue, Manlius Fire & EMS, and Orange County Emergency Management. In some embodiments, as illustrated by FIG. 8, the GUI of the primary ESP application 843A includes information regarding one or more secondary ESPs (e.g., one or more secondary ESPs within the list of secondary ESPs 801) or information regarding one or more emergency responders (e.g., one or more emergency responders associated with the one or more secondary ESPs within the list of secondary ESPs 801 or one or more emergency responders associated with one or more dispatch requests made by the primary ESP accessing the primary ESP application 843A). For example, in the example illustrated by FIG. 8, for each secondary ESP within the list of secondary ESPs 801, the primary ESP application 843A displays four categories of information: emergency responders on duty, dispatched emergency responders, response units (e.g., firetrucks, ambulances, police cars, etc.) in service, and response units out of service. In some embodiments, the information regarding secondary ESPs or emergency responders displayed within the primary ESP application 843A is received by the RDC from the secondary ESPs or emergency responders through the secondary ESP application or the emergency responder application, respectively. In some embodiments, the primary ESP application 843A provides an interface for primary ESPs to send messages to secondary ESPs or emergency responders. For example, in some embodiments, a user of the primary ESP application can select a send messages button, which prompts the primary ESP application 843A to display a messaging interface. Through the messaging interface, the user of the primary ESP application 843A can submit a message, select a secondary ESP or an emergency responder, and transmit the message to the secondary ESP or the emergency responder. In some embodiments, the message can be transmitted and displayed to the secondary ESP through the GUI of the secondary ESP application (as described above). In some embodiments, the message can be transmitted and displayed to the emergency responder through the GUI of the emergency responder application (as described above). In some embodiments, the message can be transmitted to the emergency responder in the form of a text message or an email.

### Cloud Server & RDC Integration

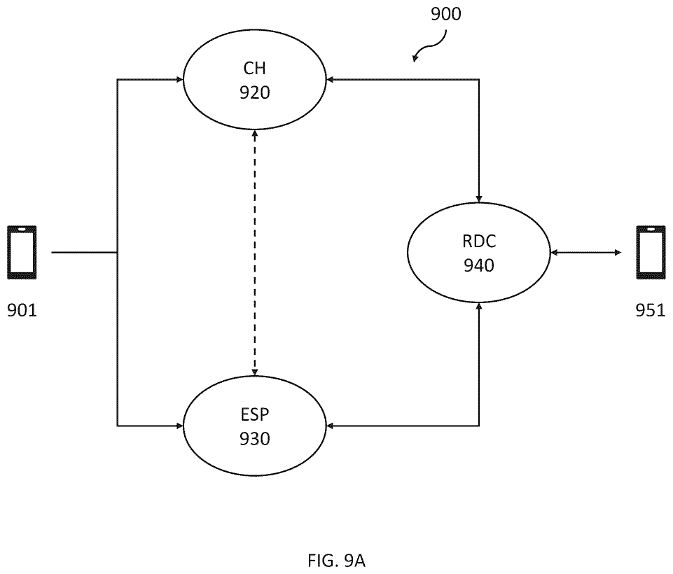

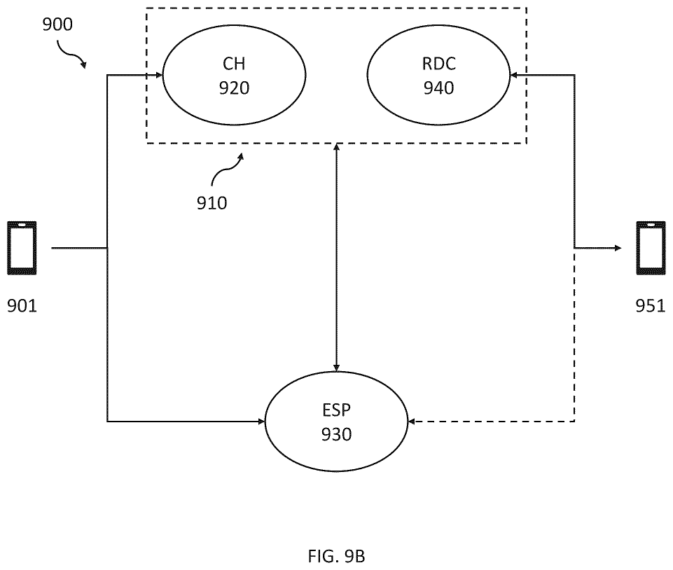

In various embodiments, as described above, disclosed herein is an emergency response data platform (cloud server) capable of receiving emergency data (e.g., device-based hybrid locations and additional emergency information, such as health data, medical data, and multimedia) from smart devices and systems (e.g., mobile phones and IoT devices) and transmitting the emergency data to emergency service providers (ESPs) to assist the ESPs in responding to emergencies. In various embodiments, also described above, disclosed herein is a responder dispatch coordination system (RDC) that facilitates communications between ESPs and emergency responders to aid emergency response networks and systems in responding to emergencies. In various embodiments, as described below, the RDC can be integrated with or into the cloud server to provide emergency response assistance to ESPs and emergency responders. FIGS. 9A and 9B depict exemplary embodiments of a system 900 for providing emergency response assistance to ESPs and emergency responders. In some embodiments, as depicted in FIG. 9A, a system 900 for providing emergency response assistance to ESPs and emergency responders includes a clearinghouse 920 (as described above), an ESP 930 (e.g., a primary or secondary ESP, as described above), and an RDC 940 (as described above). In some embodiments, as depicted in FIG. 9A, the clearinghouse 920 is communicatively coupled to the ESP 930 or the RDC 940. In some embodiments, as depicted in FIG. 9A, the RDC is communicatively coupled to the clearinghouse 920 or the ESP 930. In some embodiments, as depicted in FIG. 9A, the system 900 additionally includes one or more electronic devices 901 (e.g., a mobile phone associated with an emergency caller). In some embodiments, as depicted in FIG. 9A, the one or more electronic devices 901 are communicatively coupled to the clearinghouse 920 or the ESP 930. In some embodiments, as depicted in FIG. 9A, the system 900 additionally includes one or more emergency responder devices 951 (as described above). In some embodiments, as depicted in FIG. 9A, the one or more emergency responder devices 951 are communicatively coupled to the RDC 940 (e.g., through an emergency responder application, as described above). In some embodiments, as depicted in FIG. 9B, the clearinghouse 920 and the RDC 940 are components of the same emergency response data platform 910 (as described above).

Emergency Data Transmission to Emergency responders

As mentioned above, in various embodiments, an RDC can be integrated with or into a cloud server to provide emergency response assistance to emergency responders. In some embodiments, the cloud server can provide emergency data to the RDC. The RDC can then provide the emergency data to one or more emergency responders. For example, in some embodiments, as depicted in FIGS. 9A and 9B, when an electronic device 901 (e.g., a mobile phone) delivers a request for emergency service (e.g., by dialing 9-1-1 in the United States) to an ESP 930 (e.g., a primary ESP, as described above), the electronic device 901 also transmits an emergency alert to the cloud server (e.g., through the clearinghouse 920, as described above). In some embodiments, as described above, the emergency alert includes a user or device identifier (e.g., a phone number) and an emergency location generated by the electronic device 901. After receiving the request for emergency service, the ESP can then generate and transmit a dispatch request regarding the request for emergency service to the RDC 940. In some embodiments, as described above, the RDC 940 can parse or extract dispatch data from the dispatch request, such as a user or device identifier (e.g., a phone number) associated with the dispatch request. In some embodiments, if the RDC 940 is communicatively coupled to the clearinghouse 920, the RDC can transmit an emergency data request including the user or device identifier (e.g., a phone number associated with the dispatch request) to the clearinghouse 920. The clearinghouse 920 can then gather any available emergency data associated with the user or device identifier, such as the emergency location generated by the electronic device 901, and return the emergency data to the RDC 940. The RDC 940 can then transmit the emergency data to one or more emergency responder device 951, such as through an emergency responder application (as described above). In some embodiments, the RDC 940 transmits an emergency data request including a user or device identifier associated with a dispatch request to the clearinghouse 920 only after dispatch request has been selected from a list of dispatch requests displayed within a dispatch request screen of an emergency responder application (as described above). In some embodiments, the RDC 940 transmits an emergency data request including a user or device identifier associated with a dispatch request as soon as the RDC 940 receives the dispatch request from an ESP 930 (as described above). In some embodiments, the RDC 940 transmits emergency data received from the clearinghouse 920 and associated with a dispatch request to an emergency responder device 951 only after the dispatch request has been selected from a list of dispatch requests displayed within a dispatch request screen of an emergency responder application executed on or otherwise accessed by the emergency responder device 951.

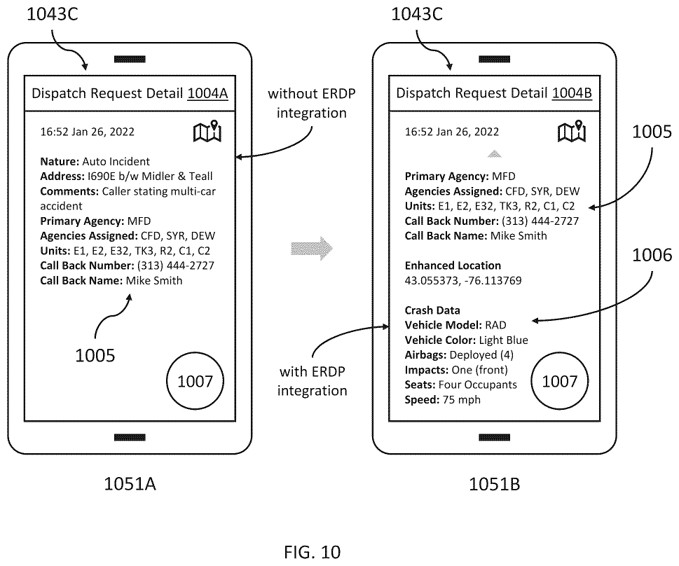

FIG. 10 illustrates an exemplary embodiment of emergency data received by the RDC, transmitted to an emergency responder device, and displayed within the graphical user interface (GUI) of an emergency responder application. As described above, in some embodiments, the RDC can query the cloud server (e.g., through the clearinghouse) by transmitting an emergency data request including a user or device identifier to the cloud server. After receiving the emergency data request from the RDC, the cloud server can use the user or device identifier to gather any available emergency data associated with the user or device identifier and return the emergency data to the RDC. The RDC can then transmit the emergency data to one or more emergency responders (e.g., to one or more emergency responder devices) to be displayed within the GUI of an emergency responder application, as illustrated by FIG. 10. In the example illustrated in FIG. 10, the GUI of the emergency responder application 1043C executed on or otherwise accessed by emergency responder device 1051A displays a dispatch request detail screen 1004A, within which the emergency responder application 1043C displays dispatch data 1005 extracted from a dispatch request by the RDC. In this example, the dispatch data 1005 that the RDC was able to extract from the associated dispatch request includes a nature of the emergency (e.g., “auto incident”), a rough description of a location associated with the dispatch request (e.g., “1690E b/w Midler & Teall”), comments, primary and secondary ESPs associated with the dispatch request, units dispatched for the dispatch request, and a call back name and number associated with the dispatch request (e.g., Mike Smith and Mike Smith's phone number). The dispatch request detail screen 1004A also displays a respond button 1007 that an emergency responder can select to identify themselves as responding to the dispatch request (as described above). For the same example dispatch request, the GUI of the emergency responder application 1043C executed on or otherwise accessed by emergency responder device 1051B displays a dispatch request detail screen 1004B, within which the emergency responder application 1043C displays the dispatch data 1005 that the RDC was able to extract from the dispatch request as well as emergency data associated with the dispatch request that the RDC has received from the cloud server (as described above). In this example, the cloud server received an emergency alert generated by a vehicle telematics system included in the car that experienced the auto incident for which the dispatch request was made. The emergency alert included emergency data generated by the vehicle telematics system, including a user or device identifier associated with the vehicle telematics system (e.g., a phone number associated with the owner of the car; in this example, Mike Smith's phone number), a location generated by the car, the model and color of the car, whether or not airbags were deployed, where the car was impacted, how many occupants were in the car, and the speed that the car was moving at the time of the incident. When the RDC received the dispatch request (as described above), the RDC extracted a user or device identifier associated with the dispatch request (e.g., a phone number associated with the dispatch request) and transmitted an emergency data request including the user or device identifier associated with the dispatch request to the cloud server. Using the user or device identifier associated with the dispatch request included in the emergency data request, the cloud server was able to retrieve the emergency data generated by the vehicle telematics system, which was associated with the same user or device identifier, and return the emergency data generated by the vehicle telematics system to the RDC. The RDC then transmitted the emergency data generated by the vehicle telematics system to the emergency responder device 1051B through the emergency responder application 1043C, where the emergency data 1006 is now displayed within the dispatch request detail screen 1004B. With the additional information provided by the emergency data 1006, the emergency responder accessing the emergency responder application 1043C on their emergency responder device 1051B will be more prepared to respond to the emergency associated with the dispatch request (e.g., the auto incident).

In some embodiments, the RDC can transmit an emergency data request including a location or geofence of interest (also referred to as a “geospatial query”) to the cloud server. After receiving the geospatial query, the cloud server can gather emergency data associated with the location or geofence of interest (e.g., emergency data associated with locations within or within a threshold proximity of the location or geofence of interest) and return the emergency data to the RDC. The RDC can then provide the emergency data to one or more emergency responders. In some embodiments, the geospatial query transmitted to the cloud server by the RDC includes a geofence of interest. In some embodiments, the geospatial query transmitted to the cloud server by the RDC includes a location of interest, and the cloud server generates a geofence of interest by applying a radius to the location of interest. In some embodiments, emergency data associated with a location or geofence of interest includes emergency alert (e.g., current emergency alerts), historic emergency alerts, emergency response assets, responder data (e.g., responder locations), or sensor data (e.g., sensor locations). However, emergency data associated with a location or geofence of interest may include any other data.

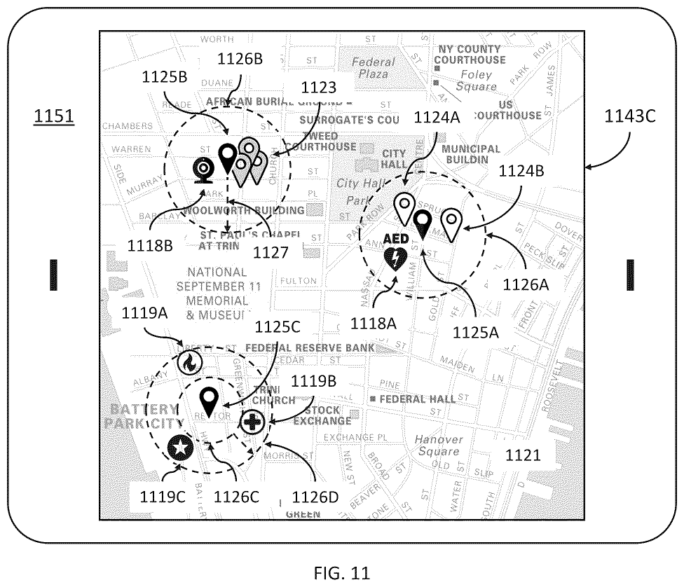

FIG. 11 illustrates three examples of geospatial queries transmitted to the cloud server from the RDC and emergency data returned to the RDC by the cloud server in response to the geospatial queries In the first example, an emergency responder has selected a location of interest 1125A within a map 1121 within a graphical user interface (GUI) of an emergency responder application 1143C executed on or otherwise accessed by the emergency responder's emergency responder device 1151 (e.g., a tablet device). In this example, in response to detecting the emergency responder's selection of the location of interest 1125A within the map 1121, the emergency responder application 1143C prompts the RDC to transmit a geospatial query comprising the location of interest 1125A to the cloud server. In this example, after receiving the geospatial query comprising the location of interest 1125A, the cloud server applied a radius around the location of interest 1125A to generate a geofence of interest 1126A and retrieved any available emergency data associated the geofence of interest 1126A (e.g., any available emergency data associated with locations within the geofence of interest 1126A). In this example, the emergency data associated with locations within the geofence of interest 1126A identified by the cloud server included two emergency alerts (e.g., current emergency alerts), each including at least a user or device identifier and an emergency location associated with the respective emergency alert, and a location associated with an emergency response asset (e.g., a smart AED). The cloud server returned the emergency data associated with the geofence of interest 1126A to the RDC, which in turn transmitted the emergency data to the emergency responder's emergency responder device 1151 through the emergency responder application 1143C, which now displays the emergency locations 1124A and 1124B associated with the two emergency alerts and the location associated with the emergency response asset 1118A within the map 1121 within the GUI of the emergency responder application 1143C. In the second example, the emergency responder has clicked on a point within the map 1121 within the GUI of the emergency responder application 1143C to select a location of interest 1125B and dragged a straight line down and away from the location of interest 1125B to apply a radius 1127 around the location of interest 1125B and thereby generate a geofence of interest 1126B. In this example, in response to detecting the emergency responder's selection of the location of interest 1126A and subsequent generation of the geofence of interest 1126B, the emergency responder application 1143C prompts the RDC to transmit a geospatial query comprising the geofence of interest 1126B to the cloud server. In this example, after receiving the geospatial query including the geofence of interest 1126B, the cloud server retrieved any available emergency data associated with locations within the geofence of interest 1126B. In this example, the emergency data associated with the geofence of interest 1126B included three historic emergency alerts, each including at least a user or device identifier and an emergency location associated with the respective historic emergency alert, and a location associated with a sensor (e.g., a traffic camera). The cloud server returned the emergency data associated with the geofence of interest 1126B to the RDC, which in turn transmitted the emergency data to the emergency responder's emergency responder device 1151 through the emergency responder application 1143C, which now displays the historic locations 1123 associated with the three historic emergency alerts and the location associated with the sensor 1118B within the map 1121 within the GUI of the emergency responder application 1143C. In the third example, the emergency responder has selected a dispatch request from within a list dispatch request displayed within a dispatch requests screen of the emergency responder application 1143C (as described above) and then selected a map button from within a dispatch request detail screen (as described below), prompting the emergency responder application 1143C to display a location associated with the dispatch request within a map 1121. In this example, in response to displaying the location associated with the dispatch request 1125C within the map 1121, the emergency responder application 1143C prompts the RDC to apply a radius around the location associated with the dispatch request 1125C to generate a geofence of interest 1126C and transmit a geospatial query including the geofence of interest 1126C to the cloud server. In this example, after receiving the geospatial query including the geofence of interest 1126C, the cloud server attempted to retrieve any available emergency data associated with the geofence of interest 1126C but found none. In this example, in response to finding no emergency data associated with the geofence of interest 1126C, the cloud server automatically increased the radius of the geofence of interest 1126C to generate a new geofence of interest 1126D. The cloud server then retrieved any available emergency data associated with the geofence of interest 1126D. In this example, the emergency data associated with the geofence of interest 1126D included three responder locations 1119A-1119C (e.g., a location associated with a firefighter 1119A, a location associated with an EMT 1119B, and a location associated with a police officer 1119C). The cloud server returned the emergency data associated with the geofence of interest 1126C to the RDC, which in turn transmitted the emergency data to the emergency responder's emergency responder device 1151 through the emergency responder application 1143C, which now displays the three responder locations 1119A-1119C within the map 1121 within the GUI of the emergency responder application 1143C.

In some embodiments, the RDC can transmit an emergency data request to the cloud server that is unrelated to any dispatch request received by the RDC or emergency alert received by the cloud server. As described above, in some embodiments, the cloud server stores or is otherwise capable of accessing or retrieving emergency data that is not generated or gathered for a particular emergency alert. For example, in some embodiments, the cloud server stores or otherwise capable of accessing personal data or medical data that is gathered from a person before that person experiences an emergency, so that the personal or medical data may be available to ESPs or emergency responders as soon as it is desired. For example, in some embodiments, the cloud server provides a web application through a person can submit personal data (e.g., home locations, emergency contacts, demographic information, etc.) or medical data (e.g., medical history, allergies, current medications, etc.) to be stored by the cloud server for future retrieval, should the person experience an emergency. Or for example, in some embodiments, a person may register or integrate an electronic device (e.g., a smartwatch) with the cloud server, such that the cloud server may retrieve data from the electronic device (e.g., heartrate data) in the event that the person experiences an emergency. In some embodiments, as described above, emergency data (e.g., personal data or medical data) stored by or otherwise accessible to the cloud server is associated with a user or device identifier (e.g., a phone number or an email address).

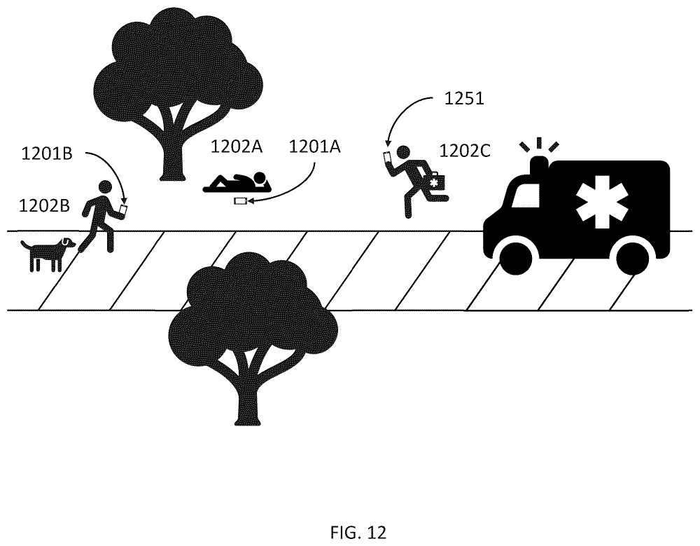

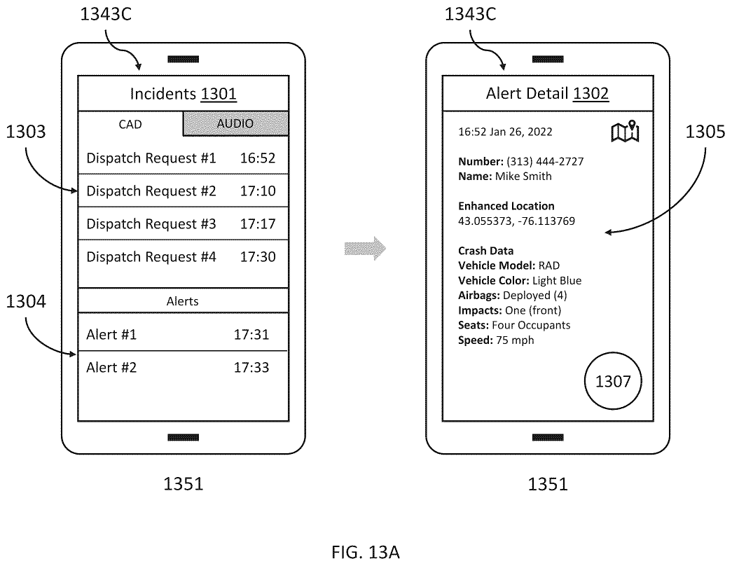

FIG. 12 illustrates an example of the RDC transmitting an emergency data request to the cloud server that is unrelated to unrelated to a dispatch request received by the RDC or an emergency alert received by the cloud server. In the example illustrated by FIG. 12, a jogger 1202A has collapsed in a park. A dog walker 1202B saw the jogger 1202A fall and fail to get up, so the dog walker 1202B called 9-1-1 on the jogger's behalf. A primary ESP (e.g., a PSAP) received the dog walker's 9-1-1 call and generated a dispatch request for the jogger's emergency that was received by the RDC. The RDC then transmitted the dispatch request to an emergency responder 1202C through an emergency responder application (as described above) executed on the emergency responder's emergency responder device 1251. The emergency responder 1202C immediately makes their way to the location included in the dispatch request (e.g., the dog walker's location, which is virtually the same as the collapsed jogger's location). However, the dispatch request included the phone number of the dog walker 1202B, because it was the dog walker 1202B that called 9-1-1, not the collapsed jogger 1202A. Similarly, an emergency alert was generated by the dog walker's electronic device 1201B (e.g., the dog walker's mobile phone) and transmitted to the cloud server, but the emergency alert also included the phone number of the dog walker 1202B, not the phone number of the collapsed jogger 1202A. Thus, the cloud server was unable to gather and transmit emergency data associated with the collapsed jogger 1202A to the RDC, and the RDC was unable to request emergency data associated with the collapsed jogger 1202A from the cloud server. In this example, when the emergency responder 1202C arrives at the location of the emergency, the emergency responder's emergency responder device 1251 can wirelessly communicate with the jogger's electronic device 1201A (e.g., using near-field communication or Bluetooth technology) to receive or identify a user or device identifier (e.g., a phone number) associated with the jogger's electronic device 1201A. The emergency responder application executed on the emergency responder device 1251 receives the user or device identifier associated with the jogger's electronic device 1201A from the emergency responder device 1251 and then prompts the RDC to transmit an emergency data request including the user or device identifier associated with the jogger's electronic device 1201A to the cloud server, which in turn gathers any available emergency data associated with the user or device identifier (e.g., medical data that the jogger 1202A previously submitted to the cloud server) and transmits the emergency data to the RDC. The RDC then transmits the emergency data associated with the user or device identifier associated with the jogger's electronic device 1201A to the emergency responder device 1251 through the emergency responder application for display within a GUI of the emergency responder application (as described above).

In some embodiments, the cloud server can transmit emergency data to the RDC without receiving an emergency data request from the RDC. For example, in some embodiments, when the cloud server receives an emergency alert (as described above), the cloud server can transmit the emergency alert to the RDC without receiving an emergency data request from the RDC and without the RDC first receiving a dispatch request associated with the emergency alert. Or for example, in some embodiments, when the cloud server receives an emergency alert (as described above), the cloud server can transmit the emergency alert to the RDC without receiving an emergency data request from the RDC and before the RDC receives a dispatch request associated with the emergency alert. In some embodiments, when the RDC receives an emergency alert from the cloud server before or without receiving a dispatch request associated with the emergency alert, the RDC determines one or more emergency responders to forward or transmit the emergency alert to. The RDC can determine one or more emergency responders to forward or transmit an emergency alert to in various ways. In some embodiments, when the emergency alert includes an emergency location, the RDC can determine one or more emergency responders to forward or transmit the emergency alert to based at least in part on the emergency location. For example, in some embodiments, after receiving an emergency alert including an emergency location, the RDC can use the emergency location and real-time locations for emergency responders (as described above) to determine or more emergency responders to forward or transmit the emergency alert to. For example, in some embodiments, the RDC forwards or transmits the emergency alert to emergency responders who have a real-time location within a predetermined radius of the emergency location. Or for example, in some embodiments, the RDC can use the emergency location and coverage areas associated with emergency responders (as described above) to determine one or more emergency responders to forward or transmit the emergency alert to. For example, in some embodiments, the RDC forwards or transmits the emergency alert to emergency responders who have a coverage area that the emergency location falls within. In some embodiments, the RDC determines one or more emergency responders to forward or transmit an emergency alert to based on emergency responders' association with secondary ESPs. For example, in some embodiments, when the cloud server receives an emergency alert including an emergency location, the cloud server cross references the emergency location with a database of geofences associated with primary ESPs (as described above). If the cloud server determines that the emergency location falls within a geofence associated with a particular primary ESP, the cloud server can tag or associate the emergency alert with an identifier associated with the particular primary ESP (also referred to as an “ESP identifier”), as described above. As described above, in some embodiments, a primary ESP is associated with one or more secondary ESPs, and a secondary ESP is associated with one or more emergency responders. Thus, in such an embodiment, when the RDC receives, from the cloud server, an emergency alert associated with a particular primary ESP (e.g., the emergency alert is tagged with an identifier associated with the particular primary ESP), the RDC can identify one or more secondary ESPs associated with the primary ESP, and then identify one or more emergency responders associated with the one or more ESPs to forward or transmit the emergency alert to. However, the RDC can determine one or more emergency responders to forward or transmit an emergency alert to in any other way. Similarly, in some embodiments, when the RDC receives an emergency alert from the cloud server, the RDC can determine one or more secondary ESPs to forward or transmit the emergency alert to (e.g., for display within the GUI of a secondary ESP application, as described above).

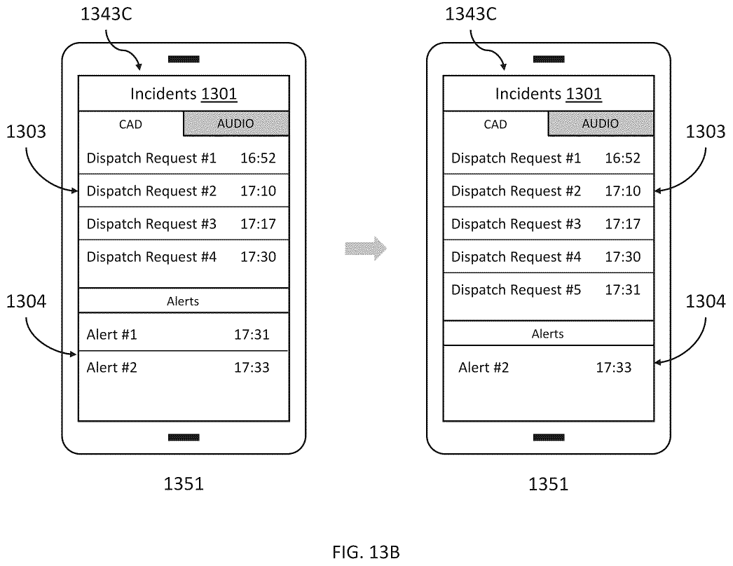

FIGS. 13A and 13B illustrate exemplary embodiments of emergency alerts transmitted by the cloud server to the RDC and displayed within a graphical user interface (GUI) of an emergency responder application. In some embodiments, as illustrated by FIG. 13A, when the RDC forwards or transmits an emergency alert to an emergency responder, the emergency alert is transmitted to the emergency responder's emergency responder device 1351 through an emergency responder application 1343C. In some embodiments, an emergency alert transmitted to an emergency responder device 1351 through an emergency responder application 1343C is displayed within a list of emergency alerts 1304 within an incidents screen 1301. In some embodiments, as illustrated by FIG. 13A, the incidents screen 1301 displays both a list of emergency alerts 1304 and a list of dispatch requests 1303 (as described above) transmitted to the emergency responder device 1351. In the example illustrated by FIG. 13A, the RDC has received two emergency alerts (i.e., emergency alerts #1 and #2) from the cloud server and transmitted the two emergency alerts to an emergency responder accessing the emergency responder application 1343C on their emergency responder device 1351. The two emergency alerts are now displayed within the GUI of the emergency responder application 1343C within the list of emergency alerts 1304. In some embodiments, as illustrated by FIG. 13A, an emergency responder can select an emergency alert from the list of emergency alerts 1304 to be shown an emergency alert detail screen 1302 that displays emergency data 1305 associated with the emergency alert. For example, in the example illustrated by FIG. 13A, the emergency responder accessing the emergency responder application 1343C has selected emergency alert #1 (e.g., Alert #1) from the list of emergency alerts 1304 and is now shown an emergency alert detail screen 1302 that displays emergency data 1305 associated with emergency alert #1. In this example, emergency alert #1 is the same emergency alert generated by the vehicles telematics system in the example described with respect to FIG. 10. In this example, however, the RDC did not need to receive a dispatch request associated with the emergency alert and transmit an emergency data request to the cloud server to receive the emergency data associated with the emergency alert. Instead, the cloud server transmitted the emergency alert (and any emergency data associated with the emergency alert) to the RDC as soon as the cloud server received the emergency alert. In this example, the RDC received the location of the emergency responder accessing the emergency responder application 1343C on their emergency responder device 1351 (e.g., the RDC received a location generated by the emergency responder device 1351 through the emergency responder application 1343C), identified the emergency responder accessing the emergency responder application 1343C as within a predetermined radius of the emergency location associated with the emergency alert (as described above), and transmitted the emergency alert to the emergency responder accessing the emergency responder application 1343C. In this way, the emergency responder accessing the emergency responder application 1343C is notified of the auto incident represented by emergency alert #1 and receives emergency data associated with the auto incident sooner than they would have been had they needed to wait to receive a dispatch request associated with emergency alert #1. In some embodiments, the emergency alert detail screen 1302 includes a respond button 1307 that the emergency responder accessing the emergency responder application 1343C can select to identify themselves as responding (as described above) to the selected emergency alert. In some embodiments, when the RDC forwards or transmits an emergency alert to an emergency responder, the emergency responder is notified in one or more ways. For example, in some embodiments, when the RDC forwards or transmits an emergency alert to an emergency responder, the emergency responder is notified in the form of a text message, an email, or a push notification (e.g., from an emergency responder application). In some embodiments, as illustrated by FIG. 13B, after the RDC transmits an emergency alert to an emergency responder for display within an emergency responder application 1343C, if and when the RDC receives a dispatch request associated with the emergency alert and transmits the dispatch request to the emergency responder for display within the emergency responder application 1343C, the emergency responder application removes the emergency alert from the list of emergency alerts 1304 or replaces the emergency alert with a dispatch request within a list of dispatch requests 1303.

### Responder Data Transmission to ESPs

As mentioned above, in various embodiments, an RDC can be integrated with or into a cloud server to provide emergency response assistance to ESPs. In some embodiments, the RDC can provide responder data (e.g., data regarding or generated by an emergency responder or the emergency responder's emergency responder device) to the cloud server. The cloud server can then provide the responder data to one or more ESPs. For example, in some embodiments, as depicted in FIGS. 9A and 9B, when an electronic device 901 (e.g., a mobile phone) delivers a request for emergency service (e.g., by dialing 9-1-1 in the United States) to an ESP 930 (e.g., a primary ESP, as described above), the electronic device 901 also transmits an emergency alert to the cloud server (e.g., through the clearinghouse 920, as described above). In some embodiments, as described above, the cloud server can then transmit the emergency alert (and any available emergency data associated with the emergency alert) to the ESP (as described above). In some embodiments, the cloud server transmits the emergency alert to the ESP through an emergency response application (as described above). In some embodiments, if the cloud server receives responder data (e.g., a responder identifier, a responder location, audio or video recorded by a responder device, notes or comments made an emergency responder, etc.) from the RDC that the cloud server can associate with the ESP or the emergency alert, the cloud server can transmit the responder data to the ESP as well (such as through the emergency response application).

In some embodiments, the RDC provides responder locations to the cloud server. For example, in some embodiments, the RDC provides every responder location received by the RDC (e.g., from an emergency responder application executed or otherwise accessed on an emergency responder device, as described above) to the cloud server. Or for example, in some embodiments, the RDC provides a responder location associated with an emergency responder to the cloud server only when the emergency responder identifies as responding to a dispatch request (e.g., by selecting a respond button within a dispatch request detail screen associated with the dispatch request within a GUI of an emergency responder application, as described above). In some embodiments, the RDC only receives a responder location associated with an emergency responder when the emergency responder identifies as responding to a dispatch request. In some embodiments, once an emergency responder identifies as responding to a dispatch request using an emergency responder application, the emergency responder application periodically gathers an updated responder location from the emergency responder device executing or accessing the emergency responder application and transmits the updated responder location to the RDC. The RDC can then transmit the updated responder location to the cloud server. In some embodiments, the RDC receives a responder location generated by a wearable device worn by an emergency responder. In some embodiments, when the RDC transmits a responder location associated with an emergency responder to the cloud server, the responder location includes, is tagged with, or is otherwise associated with a responder identifier associated with the emergency responder. A responder identifier may be any identifier associated with an emergency responder, including, but not limited to, a name, a username, a phone number, an email address, or a responder unit code. In some embodiments every emergency responder registered with the RDC (as described above) is associated with a unique responder identifier.

In some embodiments, the RDC provides additional data generated by an emergency responder or the emergency responder's emergency responder device to the cloud server. For example, in some embodiments, an emergency responder can generate or submit additional data to the RDC through an emergency responder application executed on or accessed on the emergency responder's emergency responder device (as described above). For example, in some embodiments, when responding to an emergency, an emergency responder can record audio or video of the emergency on their emergency responder device and transmit the recording to the RDC (e.g., through an emergency responder application). In some embodiments, an emergency responder can stream audio or video of an emergency to the RDC through an emergency responder application executed or accessed on their emergency responder device. After receiving a recording of audio or video from an emergency responder, the RDC can transmit the recording to the cloud server. Or for example, in some embodiments, an emergency responder can submit notes or comments regarding an emergency to the RDC. In some embodiments, when responding to an emergency, an emergency responder can generate or submit notes or comments regarding the emergency to the RDC through an emergency responder application executed or accessed on their emergency responder device. In some embodiments, when a responding to an emergency, an emergency responder can email or text notes or comments regarding the emergency to the RDC. In some embodiments, additional data generated by an emergency responder or the emergency responder's emergency responder device and received by the RDC includes, is tagged with, or is otherwise associated with a responder identifier associated with the emergency responder (as described above).

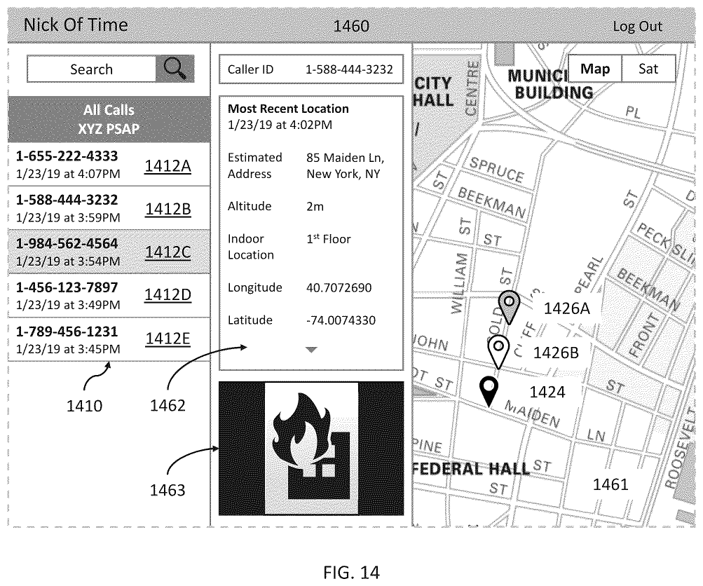

As mentioned above, in some embodiments, after receiving responder data from an RDC, the cloud server can transmit the responder data to an ESP. FIG. 14 illustrates an exemplary embodiment of responder data transmitted by a cloud server to an ESP and displayed within a graphical user interface (GUI) of an emergency response application. In some embodiments, as illustrated by FIG. 14, the GUI of an emergency response application 1460 includes a list of incidents 1410, an interactive map 1461, and a single incident card or section 1462. In some embodiments, as illustrated by FIG. 14, the list of incidents 1410 includes one or more incidents 1412A, 1412B, 1412C, 1412D, 1412E representing one or more respective requests for emergency service (e.g., emergency calls), as described above. In some embodiments, as illustrated by FIG. 14, the single incident card or section 1462 displays data (e.g., emergency data, responder data, etc.) associated with a particular incident 1412A, 1412B, 1412C, 1412D, 1412E selected from the list of incidents 1410. In some embodiments, as illustrated by FIG. 14, the interactive map 1461 displays locations (e.g., incident locations, responder locations, etc.) associated with the one or more incidents 1412A, 1412B, 1412C, 1412D, 1412E. In the example illustrated by FIG. 14, incident 1412C represents a building fire emergency for which an emergency call was made and received by XYZ PSAP (e.g., a primary ESP accessing the emergency response application 1460). In this example, the mobile phone that made the emergency call also generated and transmitted an emergency alert including a user identifier (e.g., phone number 1-984-562-4564) and an emergency location. The cloud server has transmitted the emergency alert to XYZ. PSAP (as described above). The user identifier is now displayed within the list of incidents 1410 as incident 1412C and the emergency location is now displayed within the interactive map 1461 as incident location 1424. In this example, XYZ PSAP has generated and transmitted a dispatch request, including the user identifier associated with the emergency call, for the building fire (as described above), and the dispatch request has been received and forwarded by the RDC to a fire department (e.g., a secondary ESP) and one or more firefighters (e.g., emergency responders) associated with the fire department. In this example, a firefighter has received the dispatch request through an emergency responder application accessed on the firefighter's mobile phone and identified themselves as responding to the dispatch request through the emergency responder application (as described above) The RDC has subsequently received the emergency responder's responder location from the emergency responder application and transmitted the responder location to the cloud server, which has transmitted the responder location to XYZ PSAP. XYZ PSAP selected incident 1412C from the list of incidents 1410, which prompted the emergency response application 1460 to display a single incident card 1462 for incident 1412C and display the responder location 1426A within the interactive map 1461. Two minutes later, the RDC received an updated responder location from the emergency responder application accessed on the firefighter's mobile and transmitted the updated responder location to the cloud server, which has transmitted the updated responder location to XYZ PSAP and displayed the updated responder location 1426B within the interactive map 1461. In this example, responder location 1426A (now a historic responder location) and updated responder location 1426B are displayed within the interactive map 1461 simultaneously. In this example, after arriving at the building fire, the firefighter records and transmits (e.g., streams) a video of the building fire through the emergency responder application accessed on the firefighter's mobile phone to the RDC. The RDC transmits the video to the cloud server, the cloud server transmits the video to XYZ PSAP through the emergency response application 1460, and the emergency response application 1460 now plays the video 1463 through the GUI of the emergency response application 1460.

### Responder Multimedia Sharing

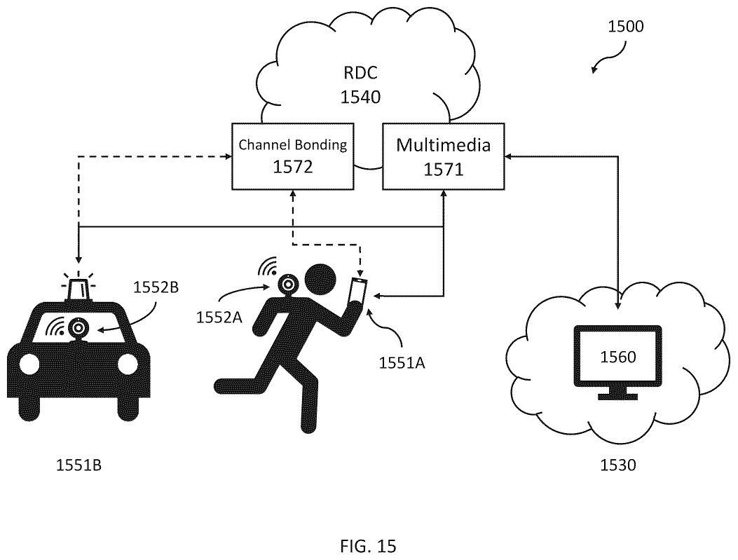

As mentioned above, in some embodiments, a responder dispatch coordination system (or an emergency response data platform (cloud server) that includes, or is otherwise communicatively coupled to, the responder dispatch coordination system (RDC)) can transmit multimedia captured or otherwise generated by an emergency responder to an emergency service provider (ESP). FIG. 15 depicts a system 1500 for sharing multimedia captured or otherwise generated by an emergency responder with an ESP. In some embodiments, as depicted in FIG. 15, the system 1500 includes an RDC 1540 (which may be included in, or communicatively coupled to, a cloud server, as described above), a responder device 1551A, and an ESP 1530. In some embodiments, as depicted in FIG. 15, the system 1500 additionally or alternatively includes a multimedia capturing device 1552A, 1552B. In some embodiments, as depicted in FIG. 15, the system 1500 additionally or alternatively includes a multimedia processing server 1571 or a channel bonding server 1572 (either or both of which may be included in the RDC 1540 or a cloud server that the RDC 1540 is included in or communicatively coupled to). In some embodiments, the channel bonding server associated with the cloud server is provided by the cloud server. In some embodiments, the channel bonding server associated with the cloud server is not provided by the cloud server. In some embodiments, the multimedia processing server associated with the cloud server is provided by the cloud server. In some embodiments, the multimedia processing server associated with the cloud server is not provided by the cloud server. In various embodiments, the components of the system 1500 work cooperatively to capture or generate multimedia associated with an emergency being responded to by an emergency responder and transmit the multimedia to an ESP.

In some embodiments, when an emergency responder responds to an emergency (e.g., when an emergency responder receives a dispatch request through an emergency responder application accessed on the emergency responder's responder device, as described above), the emergency responder employs one or more multimedia capturing devices 1552A, 1552B. For example, in some embodiments, as depicted in FIG. 15, when an emergency responder (e.g., a police officer) responds to an emergency, the emergency responder wears a body camera 1552A that records multimedia (e.g., audio or video) of the emergency responder's response to the emergency. Body cameras worn by emergency responders while they respond to emergencies can assist emergency response efforts by providing additional situational awareness. Similarly, in some embodiments, as depicted in FIG. 15, when an emergency responder responds to an emergency, a vehicle 1551B employed by the emergency responder includes one or more multimedia capturing devices, such as dashboard camera 1552B. However, a multimedia capturing device 1552A, 1552B may be any device capable of capturing or generating multimedia (e.g., photo or video) associated with an emergency being responded to by an emergency responder. For example, in some embodiments, a multimedia capturing device 1552A, 1552B and a responder device 1551A are the same device (e.g., a mobile phone).

In some embodiments, a multimedia capturing device 1552A, 1552B includes a network component (e.g., an antenna and associated components, Wi-Fi adapters, Bluetooth adapters, etc.) capable of connecting to one or more communication networks (e.g., a Wi-Fi network, a cellular network, or a satellite network) through which the multimedia capturing device 1552A, 1552B can transmit multimedia captured or generated by the multimedia capturing device 1552A, 1552B directly to the RDC 1540 (e.g., to a multimedia processing server 1571 included in or otherwise communicatively coupled to the RDC 1540). The RDC 1540 (or a multimedia processing server 1571 included in or otherwise communicatively coupled to the RDC 1540) can then transmit the multimedia captured or generated by the multimedia capturing device 1552A, 1552B to one or more recipients, such as an ESP 1530. However, in some embodiments, a multimedia capturing device 1552A, 1552B cannot connect to a communication network through which the multimedia capturing device 1552A, 1552B can transmit multimedia directly to the RDC 1540. For example, in some embodiments, the network component of a multimedia capturing device 1552A, 1552B can only connect to a Wi-Fi network (e.g., the network component does not have cellular connectivity). In such an embodiment, if there is no Wi-Fi network within range of the multimedia capturing device 1552A, 1552B, the multimedia capturing device 1552A, 1552B cannot transmit multimedia directly to the RDC 1540.

In some embodiments, when a multimedia capturing device 1552A, 1552B cannot connect to a communication network through which the multimedia capturing device 1552A, 1552B can transmit multimedia directly to the RDC 1540, the multimedia capturing device 1552A, 1552B can transmit multimedia to the RDC 1540 indirectly, such as by establishing a communication link with a second device that is able to transmit multimedia directly to the RDC 1540 (e.g., a responder device 1551A with cellular network connectivity). Because a multimedia capturing device 1552A, 1552B with cellular network connectivity can be significantly more expensive than a multimedia capturing device 1552A, 1552B without cellular network connectivity, indirectly transmitting multimedia from a multimedia capturing device 1552A, 1552B to an RDC 1540 (e.g., through a communication link established between the multimedia capturing device 1552A, 1552B and a responder device 1551A with cellular or Wi-fi network connectivity) can be a more economical solution for emergency responders and first response agencies. In some embodiments, when a multimedia capturing device 1552A, 1552B does not have cellular network connectivity, in order to indirectly transmit multimedia from a multimedia capturing device 1552A, 1552B to an RDC 1540, the multimedia capturing device 1552A, 1552B generates or otherwise provides a wireless access point (e.g., a hotspot) that other devices can connect to. Although the multimedia capturing device 1552A, 1552B does not have cellular network connectivity, and thus cannot provide internet access to a device that connects to the wireless access point provided by the multimedia capturing device 1552A, 1552B, the multimedia capturing device 1552A, 1552B can communicate with any device that connects to the wireless access point provided by the multimedia capturing device 1552A, 1552B. Thus, when a responder device 1551A connects to the wireless access point, the multimedia capturing device 1552A, 1552B can transmit multimedia (e.g., a stream of multimedia) captured or generated by the multimedia capturing device 1552A, 1552B to the responder device 1551A through a communication link established between the multimedia capturing device 1552A, 1552B and the responder device 1551A through the wireless access point. The responder device 1551A can then transmit the multimedia (e.g., the stream of multimedia) to the RDC 1540 (or a multimedia processing server 1571 included in or otherwise communicatively coupled to the RDC 1540, as described below) Once the RDC 1540 (or a multimedia processing server 1571 included in or otherwise communicatively coupled to the RDC 1540) has received the multimedia (e.g., the stream of multimedia) from the responder device 1551A, the RDC 1540 (or the multimedia processing server 1571) can then transmit the multimedia (e.g., the stream of multimedia) to an ESP 1530 (such as through an emergency response application 1560 executed on a computing device associated with the ESP, as described above).

For example, in the example depicted in FIG. 15, a mobile application (e.g., a responder application, as described above) executed on a responder device 1551A (e.g., a mobile phone) has received a dispatch request (as described above) from an ESP. In this example, an emergency responder associated with the responder device 1551A has indicated (e.g., through the responder application) that he is responding to the dispatch request. In this example, in response to the emergency responder indicating that he is responding to the dispatch request, the mobile application executed on the responder device 1551A has established a first communication link between the responder device 1551A and a multimedia capturing device 1552A (e.g., a body camera worn by the emergency responder) through a wireless access point provided by the multimedia capturing device 1552A (as described above) and a second communication link between the responder device 1551A and the RDC 1540 (or a multimedia processing server 1571 included in, provided by, or otherwise communicatively coupled to the RDC 1540) through a cellular communication network accessible by the responder device 1551A. In this example, after the first and second communication links are established, the multimedia capturing device 1552A begins transmitting multimedia (e.g., a stream of multimedia, such as a video stream) to the responder device 1551A. The mobile application receives the multimedia transmitted from the multimedia capturing device 1552A to the responder device 1551A through the first communication link and then transmits the multimedia to the RDC 1540 (e.g., to a multimedia processing server 1571 included in, provided by, or otherwise communicatively coupled to the RDC 1540) through the second communication link. The RDC 1540 (or the multimedia processing server 1571) can then transmit the multimedia to an ESP (e.g., the ESP that generated the dispatch request). In some embodiments, the multimedia capturing device 1552A transmits the multimedia to the responder device 1551A (e.g., to the mobile application executed on the responder device 1551A) through a first protocol, and the responder device 1551A (e.g., the mobile application executed on the responder device 1551A) transmits the multimedia to the RDC 1540 (or to a multimedia processing server 1571 associated with the RDC 1540) through a second protocol different from the first protocol. For example, in some embodiments, the multimedia capturing device 1552A transmits the multimedia to the responder device 1551A through the real-time streaming protocol (RTSP), and the responder device 1551A transmits the multimedia to the RDC 1540 through the real-time messaging protocol (RTMP). In some embodiments, the responder device 1551A (e.g., the mobile application executed on the responder device 1551A) transmits the multimedia to the RDC 1540 (or to a multimedia processing server 1571 associated with the RDC 1540) through a first protocol, and the RDC 1540 (or the multimedia processing server 1571) transmits the multimedia to an ESP through a second protocol different from the first protocol. For example, in some embodiments, the responder device 1551A transmits the multimedia to the RDC 1540 through the RTSP protocol or the RTMP protocol, and the RDC 1540 transmits the multimedia to an ESP through the web real-time communication protocol (WebRTC) or the HTTP live streaming protocol (HLS).

As described above, in some embodiments of the system 1500, a mobile application executed on a responder device 1551A establishes a first communication link with a multimedia capturing device 1552A, 1552B through a wireless access point provided by the multimedia capturing device 1552A, 1552B a second communication link with an RDC 1540 (or a multimedia processing server 1571 associated with the RDC 1540) through a cellular communication network. The mobile application can then receive multimedia (e.g., a stream of multimedia) from the multimedia capturing device 1552A, 1552B through the first communication link, and transmit the multimedia to the RDC 1540 through the second communication link. In some embodiments, as mentioned above, the system 1500 includes a channel bonding server 1572 configured to manage the reception of the stream of multimedia from the multimedia capturing device to the mobile application through the first communication link and the transmission of the stream of multimedia from the mobile application to the multimedia processing server through the second communication link. In general, channel bonding refers to the dynamic aggregation of two or more network connections (e.g., communication links) to enable additional or enhanced functionality (e.g., greater connectivity, throughput, speed, reliability, or redundancy) that the individual network connections could not otherwise provide. In some embodiments of the system 1500, even if the responder device 1551A has established more than one network connection (e.g., a first communication link established through a wireless access point provided by a multimedia capturing device 1552A, 1552B and a second communication link established through a cellular communication network, as described above), the responder device 1551A only allows applications executed on the responder device 1551A to send and receive data through one network connection at a time (e.g., the responder device 1551A gives preference to a Wi-Fi connection over a cellular connection). In some such embodiments, the mobile application executed on the responder device 1551A can establish a third communication link with a channel bonding server 1572 (e.g., through the cellular communication network), and establish a virtual private network (VPN) with the channel bonding server 1572 through the third communication link. Through the VPN established by the mobile application executed on the responder device 1551A, the channel bonding server 1572 can ensure that multimedia is received by the mobile application from the multimedia capturing device 1552A, 1552B through the first communication link (i.e., the communication link established between the multimedia capturing device 1552A, 1552B and the mobile application through the wireless access point provided by the multimedia capturing device 1552A, 1552B) and transmitted by the mobile application to the RDC 1540 through the second communication link (i.e., the communication link established between the mobile application and the RDC 1540 through the cellular communication network.

### Sharing Streams of Multimedia

In addition to multimedia feed from emergency responders, the systems, methods, and interfaces disclosed herein may be used for sharing streams of multimedia between users in an emergency, an emergency service provider (ESP), and emergency responders as described below. In some embodiments, a mobile application on a user device (e.g., mobile phone of a user in an emergency, emergency responders) establishes a first communication link with a multimedia capturing device through a wireless access point provided by the multimedia capturing device. It is understood that the multimedia device may be a recording device available in the marketplace such as a CCTV camera, a bullet camera, a turret camera, a dome camera, a pan-tilt-zoom (PTZ) camera, a pan-tilt (PT) camera, cube camera, flood light camera, video doorbell, fisheye camera, spotlight camera, freestanding cameras, web cams, license plate recognition (LPR) camera, positioning camera, multi-sensor panoramic camera, corner camera, thermal camera, wall light camera, dashcam, etc. In some embodiments, the multimedia capturing device generates the stream of multimedia. In some embodiments, the multimedia capturing device stores the stream of multimedia from the past, such as images of an intruder with a gun.

In some embodiments, the mobile application on the user device also establishes a second communication link with a multimedia processing server (such as the multimedia processing server 1571 in FIG. 15). The multimedia processing server provides a centralized storage of multimedia content, such as photos, videos, audio, sensor and other digital media files and allows authorized recipients in the public safety dispatch chain to gain access at critical times for effective and efficient emergency response as described below.

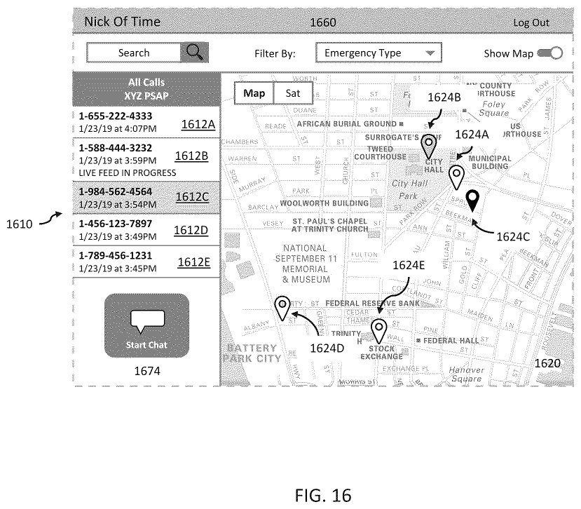

FIG. 16 illustrates an embodiment of a GUI 1660 provided by an emergency response application for an ESP user (e.g., a telecommunicator) to start a communication channel with a user device (e.g., a caller reporting a medical emergency as described in Example 3). In some embodiments, the GUI includes a call queue 1610 with a list of emergency calls and an interactive map 1620. As depicted, the location of each emergency call 1612A-E is indicated by location markers 1624A-E on the interactive map 1620. Here, the ESP user can see that emergency call 1612A is sharing live feed with another user in the system and the location marker has a visual different from other location markers. In this case, the ESP user selects the next emergency call 1612C in the queue 1610 and is presented with a “start chat” button 1674 to initiate a communication session with the emergency caller. In some embodiments, an ESP user may initiate a message to the phone number by text, data SMS, HTTP, or other types of messages.

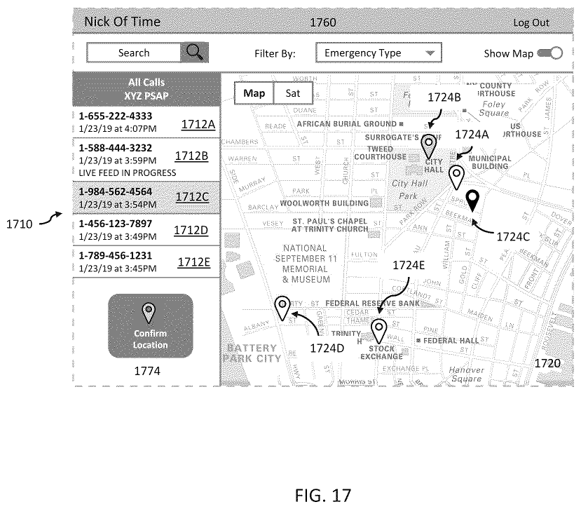

As location is a critical piece of emergency data, the ESP user may confirm the location of the emergency caller by various ways. For example, FIG. 17 illustrates an embodiment of a GUI 1760 provided by an emergency response application for an ESP user to confirm the location of the user device. As depicted, the location of each emergency call 1712A-E in the call queue 1710 is indicated by location markers 1724A-E on the interactive map 1720. Selection of the confirm location button 1774 will initiate a request for a device-based hybrid location of the user device. Once the location data is received from the user device, the location marker 1724 on the interaction map 1720 may be adjusted accordingly.

In some embodiments, the location of the user device may be in the vicinity of the location of the multimedia device such as a camera. The user device may connect to the camera via a first communication link, such as Wi-fi hotspot. Thus, the location of the user device would be within the range of Wi-fi, typically within 150 feet in indoor locations and within 300 feet in outdoor locations.

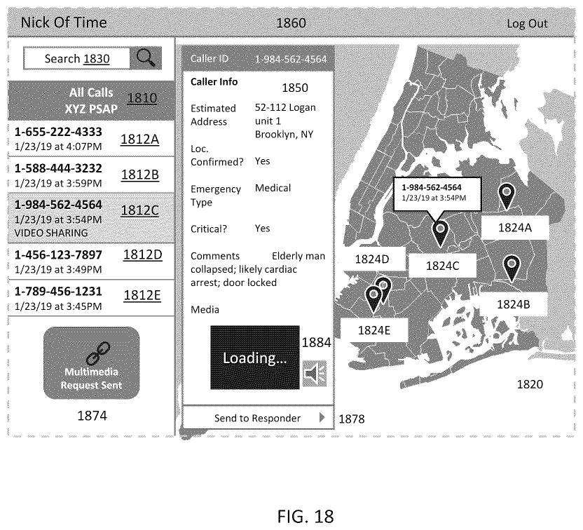

FIG. 18 illustrates an embodiment of a GUI 1860 provided by an emergency response application for sending a multimedia request to a user device In some embodiments, the GUI includes a call queue 1810 with a list of emergency calls, a search function 1830, and an interactive map 1820. As depicted, the location of each emergency call 1812A-E in the call queue 1810 is indicated by location markers 1824A-E on the interactive map 1820. Selection of the emergency call 1812C causes the corresponding location marker 1824C visually indicating the selection with a blurb and opening a data card 1850 with the emergency data related to the emergency call. In this case, the emergency caller reported elderly man collapsed who is likely cardiac arrest and the front door is locked as described in Example 3. Although not shown, the telecommunicator may enter notes about the emergency call that can become part of the emergency data associated with the emergency call and then forwarded to CAD. Here, an option is displayed for sharing the emergency data associated with the emergency call including a multimedia feed to an emergency responder via 1878. In this way, the medical condition of the elderly man can be viewed and monitored by responders to prepare for effective and efficient response.

Here, the selection of multimedia request button 1874 by a telecommunicator initiates a request to be sent to the user device. Once the video feed is received, the feed may be displayed in the media screen, now showing “loading . . . ” It is contemplated, there could be disturbing scenes shown in the video and the ESP user may be given control options for the multimedia feed such as no sound 1884, blur (not shown), end feed (not shown), etc. In this way, the multimedia feed can be removed by the ESP user for disturbing or inappropriate content.

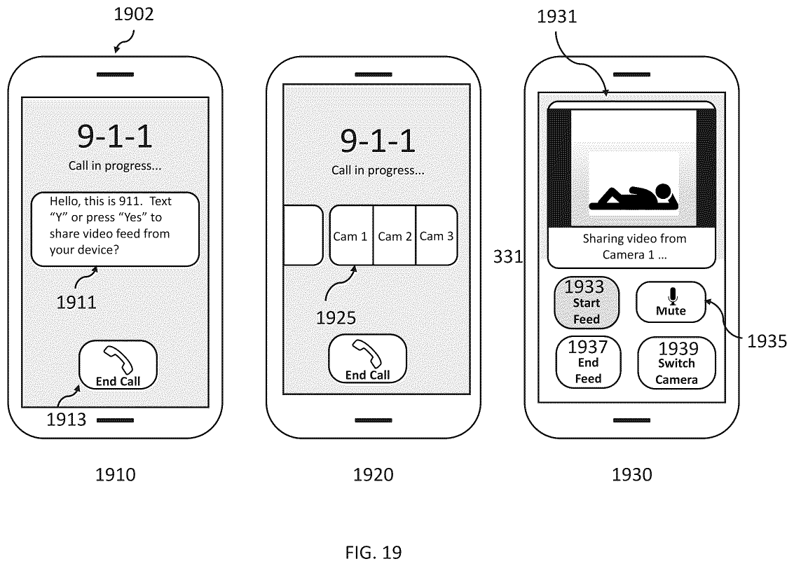

An example of the interactions between a user in an emergency on the user device and the ESP user on the emergency response application is visualized in FIG. 19. As shown, a GUI provided by a mobile application on the user device 1902, where the supervisor in the building has called in the medical emergency regarding the elderly resident who had a heart attack.

As depicted in GUI screen 1910, an emergency call is in progress when an ESP user can initiate a text message 1911. The user can decide to to end call 1913 and continue the conversation over the text message.

It is contemplated the caller is provided options to share the multimedia feed in various ways. In the GUI screen 1920, there are options 1925 to choose the camera to be selected for the multimedia sharing. In this way, the caller can provide consent for sharing multimedia content. In GUI 1930, the video feed from camera 1 is displayed showing the elderly man on the floor in the multimedia feed 1931. In some embodiments, the caller has several options on the user device such as start feed 1933, end feed 1937, mute 1935 or switching camera 1939.

It is contemplated that the stream of multimedia that provides situational awareness may be real-time or near real-time video or audio feed. Thus, the stream of multimedia can continue to provide up-to-date information about the emergency to responders, which can provide information such as the state of consciousness of a patient, medical symptoms, etc. In some embodiments, the stream of multimedia is real-time or near real-time feed generated by a camera or a microphone. Pre-recorded multimedia feed can also provide critical information about the emergency even if it is not up-to-date. For example, a pre-recorded multimedia feed from 5 minutes ago could show that the elderly man's symptoms to indicate whether there was a heart attack. In addition, the multimedia feed can show medical equipment such as oxygen tank nearby, which may be also helpful for the emergency response.

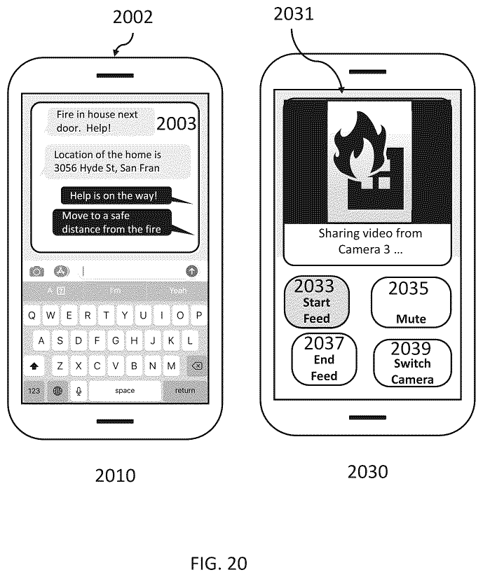

Systems and methods for sharing a stream of multimedia are depicted in FIGS. 20-22 as described in Example 4. FIG. 20 illustrates an embodiment of a GUI provided by a mobile application on a user device for sending stream of multimedia. Specifically, GUI screen 2010 shows a text-to-911 exchange on the user's device 2002. The text exchange 2003 is between a user who is reporting a fire in the house next door and an emergency service provider (e.g., a PSAP responsible for responding to emergencies at that location). Here, the 911 telecommunicator indicates that help is on the way and the user should get to safety to wait for emergency responders. Text-to-911 is an alternate pathway to connect to 911 in addition to making an emergency call and is available in limited jurisdictions.

Systems and methods herein can provide additional functionality of rich multimedia feed that can be made available to telecommunicators and can be passed on to dispatchers (via CAD) and responders (via an emergency responder application). As depicted in GUI screen 2030, the user can provide consent for sharing the multimedia feed 2031. In some embodiments, the user has various control options for the multimedia feed 2031 such as start feed 2033/end feed 2037, mute 2035, switch camera 2039, etc.

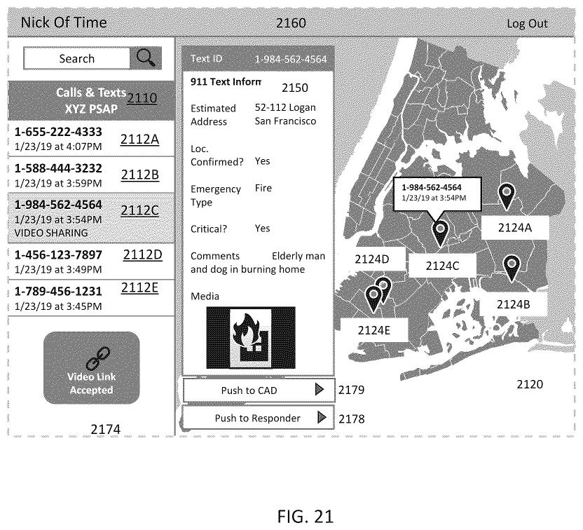

As described in Example 4, the telecommunicator may be able to send a multimedia request to the user reporting the fire by interacting with a GUI in the emergency responder application. FIG. 21 illustrates an embodiment of a GUI provided by an emergency response application for receiving a stream of multimedia from a user device.

In some embodiments, the GUI 2160 includes a call queue 2110 with a list of emergency calls, and an interactive map 2120. As depicted, the location of each emergency call 2112A-E in the call queue 2110 is indicated by location markers 2124A-E on the interactive map 2120. Selection of the emergency call 2112C causes the corresponding location marker 2124C visually indicating the selection with a blurb and opening a data card 2150 with the emergency data related to the emergency call. In this case, the user reported a fire in the home next door by text-to-911 as described in Example 4. The telecommunicator may enter notes about the emergency call that can become part of the emergency data associated with the emergency call and then forwarded to CAD via 2179. Here, an option is displayed for sharing the emergency data associated with the emergency call including a multimedia feed to an emergency responder via 2178. In this way, the existence and extent of the fire can be evaluated before entering the home. In addition, the emergency responders can review the video feed to establish the existence of people and pets in the home and also determine the best approach to enter the home. In this way, the rich multimedia feed can be immensely valuable to emergency responders.

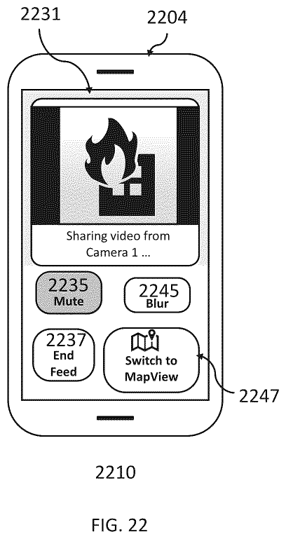

An exemplary GUI on a responder device is depicted in FIG. 22. As depicted, an embodiment of a GUI provided by a mobile application for receiving a stream of multimedia from a user device. In GUI screen 2210 of the responder application, the stream of multimedia 2231 is received and displayed to provide situational awareness about the fire to the emergency responder. In some embodiments, the responder is provided with various options including ending the feed 2237, mute 2235, blur 2245, and switching to the Map View 2247 (similar to the GUI shown in FIG. 21). It is contemplated, there could be disturbing scenes shown in the multimedia and the ESP user should be given control options for the multimedia feed such as no sound, blur, end feed, repositioning, zooming, etc. to reduce or eliminate the negative impact on the ESP user. In this way, the multimedia feed can be removed by the ESP user for disturbing or inappropriate content.

### EXAMPLES

The following illustrative examples are representative of embodiments of the invention(s) described herein and are not meant to be limiting in any way.

### Example 1

On My Way! is an emergency response company that aids emergency service providers (ESPs; e.g., public safety answering points, or “PSAPs”) and emergency responders alike by providing an emergency notification and response system that gathers emergency data and conveys that information directly to the emergency service providers and emergency responders.

Traditionally, when a PSAP receives a 911 call, a telecommunicator at the PSAP will analyze the situation and notify the appropriate emergency response agency. The emergency response agency (e.g., fire station, police station, emergency medical services (EMS); hereinafter, “secondary agency”) will select the emergency responders who will be responding to the emergency. If the secondary agency relies on volunteer responders, as seen in rural volunteer fire departments, the responders are often located remotely from the station and are on-call. In these instances, the on-call responders are given five minutes to confirm whether they are responding to the emergency. Within that time frame, a house fire can go from miniscule to catastrophic. On My Way! understands how critical it is to quickly notify responders and respond to a dispatch request as soon as possible.

To facilitate a quick notification and response procedure, On My Way! maintains and provides a web- and application-based tool that allows end users (i.e., emergency responders) to be notified of a dispatch request in one second or less. The PSAP will use a computer automated dispatch (CAD) system to send a dispatch request to the On My Way! system in the form of an email (SMTP or SNPP). The On My Way! website display screens will then display that dispatch request and notify the available responders. The method by which a responder is notified can consist of a text message, email, phone call, or push notification via the On My Way! app. The responder can select which method or methods they prefer, allowing for a redundancy in notifications. The responder has 30 seconds to respond to the dispatch notification before another notification is sent. Their response is then displayed on a screen located at the secondary agency where the secondary agency can view it. Compared to the traditional five-minute window, this faster response time can reduce unnecessary delay and allow for responders to get to the scene more quickly and efficiently.

On My Way! is also able to capture live audio via a Radio Dispatch Monitoring System (RDMS). Typically, when a dispatch request is sent from the PSAP, it is sent via two-way radio and emits a sound consisting of two differently pitched tones. RDMS is able to listen for the two tones and begin recording the audio from the dispatch request made by the PSAP. The audio is captured directly by the On My Way! servers from a user's computer where the RDMS software is downloaded. When the audio recording is complete, the On My Way! system will alert the responders via the On My Way! app that the recording is available, where they can then stream the audio from the server. In addition to app notifications, responders are also able to receive a hyperlink to the recording via text message or email.

Ariana, the administrator of a PSAP, learns of the ways in which On My Way! aids emergency response and joins the over 9,000 agencies who rely on On My Way!. On My Way! assigns her agency a unique email address so that when a dispatch request is sent to the On My Way! system, it is identifiable as sent from Ariana's PSAP. Bailey, a fire chief in Ariana's jurisdiction, uses her administrative log-in to create profiles for each firefighter under that jurisdiction and a member identification number is generated and linked to her agency. Her agency is able to use On My Way!'s interactive map to place markers indicating the location of vital information, including fire hydrants, gas stations, and automated external defibrillators (AEDs). In addition, the On My Way! display screen at the fire department allows Bailey to see responder information, including who is on duty, their position, and when they are on duty until. Each agency and responder is given the option to fully customize their display screen so it can be configured to meet their information and stylistic preferences. Cat, who is a volunteer firefighter for Bailey's agency, lives outside of the range of her department's radio dispatch and is often unable to receive dispatch requests via her two-way radio. Fortunately, Cat's department employs On My Way!'s technology, which allows her to receive notifications on her cell phone, no matter her location.

One day, a fire alarm is triggered in an apartment downtown and Ariana's PSAP receives several emergency calls. Ariana is able to quickly dispatch Bailey's fire department via the On My Way! system by emailing a dispatch request to On My Way! and sending out a dispatch request over the radio. In response, On My Way! sends dispatch notifications to all on-duty firefighters within Ariana's PSAP's jurisdiction. When Cat receives the push notification from the On My Way! app about the fire, she is able to quickly indicate that she will be responding and can obtain vital information from sensor data, including the time when the smoke alarms were triggered. Cat is concerned because the address of the fire is located in a densely populated area. She is able to use the On My Way! app to make a plan on how best to approach the fire, including viewing nearby fire hydrants, fire extinguishers, or buildings in close proximity, as well as determining the number of people who live in the building. This address looks very similar to Cat's friend's apartment and Cat wants to receive more information. Thanks to RDMS, she is easily able to listen to the recording of the dispatch request made over the radio via the On My Way! app and confirm the location of the fire, as well as how many people need help in the building. When Cat arrives at the fire, she already has a plan in place and is able to quickly and efficiently respond to the emergency. Since saving a few minutes can mean the difference between life or death, Cat, as well as the people in the emergency, are grateful for the life saving features provided by On My Way!.

### Example 2

Just In Time, an emergency response company, aids public safety services (such as public safety answering points, or “PSAPs”) by gathering data related to emergencies from a variety of sources and delivering the data directly to the public safety services through digital services and applications. In one example of Just In Time's technologies, Just In Time maintains and provides an Emergency Clearinghouse (hereinafter, “clearinghouse”) that receives and stores data and information from a plurality of sources, such as mobile phone and mobile applications, internet of things (IoT) devices, intelligent vehicle systems, and other electronic devices. During an emergency, the clearinghouse can gather information stored within or received by the clearinghouse regarding the emergency and deliver the information to PSAPs. In order to provide access to the information stored within or otherwise accessible to the clearinghouse to PSAPs as quickly and easily as possible, Just In Time develops and provides an emergency response application, Nick Of Time, in the form of a website accessible via a standard web browser. To further aid public safety services, Just In Time integrates their clearinghouse with the On My Way! system described in Example 1, so that Just In Time can provide data from the clearinghouse to On My Way! (and, by extension, the emergency responders that On My Way! supports) and so that On My Way! can provide data from emergency responders to Just In Time (and, by extension, the public safety services that Just In Time supports).

A PSAP in San Jose, California regularly employs Nick Of Time on the PSAP's computing devices. When a man on a hike outside of San Jose (but still within the jurisdiction of the San Jose PSAP) feels a pain in his chest, the hiker calls 9-1-1 on his mobile phone but collapses before the emergency call is answered by Jacob, a telecommunicator at the San Jose PSAP. Jacob can hear the sounds of the hiker struggling but is not able to communicate with the hiker. However, when the emergency call was made by the biker's mobile phone, the mobile phone also generated and transmitted an emergency alert including the hiker's phone number and location (generated by the hiker's mobile phone) to Just In Time. Communicatively coupled to the hiker's smartwatch, the hiker's mobile phone also begins transmitting heartrate data generated by the hiker's smartwatch to Just In Time as well. In addition, the hiker has previously submitted information including his medical conditions within a medial ID app on the hiker's phone, and the medical ID app information is transmitted by the hiker's mobile phone to Just In Time as well. Although Jacob cannot communicate with the hiker directly, Just In Time uses the hiker's location to determine that the hiker is within the jurisdiction of Jacob's PSAP and automatically transmits the hiker's phone number and location, the heartrate data generated by the hiker's phone, and the hiker's medical ID app information to the San Jose PSAP through an instance of Nick Of Time being accessed on Jacob's PSAP computer. With this information, Jacob is able to quickly determine that the hiker may be having a cardiac emergency and sends out a dispatch request for the hiker to emergency medical personnel within the jurisdiction of the San Jose PSAP. In the dispatch request, Jacob is able to include the hiker's name and location (received from Just In Time) and an indication that the emergency may be a cardiac emergency. Jacob's dispatch request is received by On My Way! and then transmitted by On My Way! to all of the emergency medical personnel registered with On My Way! and servicing the jurisdiction of the San Jose PSAP.

Sarah, a volunteer EMT in San Jose, receives a dispatch notification regarding Jacob's dispatch request from On My Way! in three ways—as a text message, as an email, and as a push notification from the On My Way! mobile application installed on Sarah's mobile phone. Sarah clicks on the push notification to open the On My Way! mobile application and see details regarding Jacob's dispatch request. Within the On My Way! mobile application, Sarah sees the location of the hiker and that the hiker may be having a cardiac emergency. Sarah happens to be close to the location of the biker and immediately selects a button within the On My Way! mobile application to identify herself as responding to Jacob's dispatch request. Then she begins driving to the hiker's location. When Sarah identifies herself as responding to Jacob's dispatch request, the On My Way! system transmits Sarah's phone number and location to Just In Time, which then transmits Sarah's phone number and location to the San Jose PSAP through the instance of Nick Of Time being accessed on Jacob's PSAP computer, where Jacob can see Sarah's location in real-time as she drives toward the hiker's location. In addition, Just In Time returns the hiker's medical ID app information to the On My Way! system, which transmits and displays the medical ID app information within Sarah's On My Way! mobile application, providing Sarah with even more situational awareness. Still on the emergency call with the hiker, Jacob is able to tell the hiker that an emergency responder is on the way and exactly the direction that the emergency responder is coming from. The hiker manages to tell Jacob that the hiker has injured his ankle as well. Through Nick Of Time, Jacob is able to send a message to Sarah saying that the hiker has also injured his ankle, and Sarah receives the message through the On My Way! mobile application. This is a level of visibility and communication with a volunteer emergency responder that Jacob would never have had before the integration of the On My Way! and Just In Time systems.

### Example 3

Homer, an elderly man in his eighties, lives in unit #24 in Green Valley senior housing facility in the southwest side of City A, which falls within the jurisdiction of an Emergency Dispatch Center, i.e. PSAP XYZ.

At 9:05 pm, Homer presses a panic button on his wearable necklace as he collapses on the floor. The panic button sends an alert to the supervisor A in the building. When supervisor A arrives at the Homer's door, it is locked and John is also not answering his phone. Homer's file indicated that he is at a high risk of a heartache, so Supervisor A becomes concerned that Homer may have had a heart attack.

Supervisor A immediately calls 911 to get help for Homer. The emergency call is answered by Mary TC, a telecommunicator at the PSAP XYZ. Supervisor A confirms the location of the emergency and requests medics to bring a defibrillator in case Homer has had a heart attack.

Mary TC is aware that it will be helpful for dispatch to have accurate information about Homer's condition for responding to the emergency. Sometimes, emergency responders, such as medics are sent to false alarms, while people in need are left waiting. Mary asks if there is a way to confirm that Homer is actually having a medical emergency and not opening the door for another reason (e.g., he has fallen asleep and can't hear the knock or the phone).

Supervisor A remembers there are Wi-fi cameras in the kitchen and hallway in Homer's unit. He searches for the Wi-fi hotspot for the camera 1 (kitchen) and camera 2 (hallway) and is able to connect via his mobile phone to camera 1. Previously, Homer had shared the password for the cameras in his unit with the staff at Green Valley for accessing during emergencies. Supervisor A accesses feed from camera 1 and can see Homer flat on his kitchen floor. Supervisor informs Mary TC on the emergency call and offers to show her Homer's position and distressed movements via video feed from camera 1.

Mary TC uses Nick of Time web platform to send a text message to Homer's mobile phone with a link to web browser for sharing the video feed that the mobile phone is accessing via Wi-fi hotspot. Mary passes the incident into CAD for dispatch and includes situational information for the emergency response: “Subject is having a medical emergency; likely cardiac arrest. Send responders for breaking down front door and medics with defibrillator.”

Vicky, a medic is dispatched in an ambulance to respond to the emergency. Using the Nick of Time web browser application, he can view the emergency data about the caller, Supervisor A including a link to access the video feed from the scene.

Ricky is a fireman and Vicky medic arrive on the scene to respond to Homer's emergency. While Ricky works on breaking down the front door, Vicky would like to monitor the patient using camera 1. Using his mobile phone, Vicky connects to the camera 1 hotspot and accesses the video feed. Based on the signs, Vicky prepares the defibrillator and other equipment to provide medical intervention.

As soon as the door opens at 9:11 pm, Vicky enters Homer's unit and provides medical intervention to save his life. Homer recovers from the heart attack and returns home to Green Valley.

### Example 4

John, a resident of Hometown sends a text-to-911 message about a fire in a home next door in the northwest side of City A, which falls within the jurisdiction of an Emergency Dispatch Center, i.e. PSAP XYZ. The message is received by Mary TC who responds with a text confirming that help is on the way and that John should evacuate the area in case the fire spreads.

Harry Responder, a part time fire volunteer arrives on the scene in front of the home. With the help of knowledgeable neighbors, he finds out that John is an elderly man who lives in the house with his dog.

Harry Responder could see smoke coming out of the building, but doesn't know where the fire is and if there are any people or pets are inside. He uses his mobile phone to look for any Wi-fi devices and finds a Wi-fi camera (hallway) and connects to the Wi-fi. He is able to access the feed to see that the fire is heavy in hallway near the front door and he will have to approach from the back entrance. As he approaches from the back entrance, he sees that the stairs are also covered in thick smoke. Then, he decides to use the ladder to approach the second floor bedrooms. As he approaches, he can hear the dog and John yelling for help. Harry and his team rescued John and his dog first and then worked to extinguish the fire.

Those skilled in the art will recognize that a wide variety of other modifications, alterations, and combinations can also be made with respect to the above-described embodiments without departing from the scope of the disclosure, and that such modifications, alterations, and combinations are to be viewed as being within the ambit of the inventive concept.

All publications, patents, and patent applications mentioned in this specification are herein incorporated by reference to the same extent as if each individual publication, patent, or patent application was specifically and individually indicated to be incorporated by reference.

What is claimed:

1. A method for transmitting multimedia from a user device to an emergency service provider (ESP), the method comprising:
establishing, by a mobile application executed on a user device, a first communication link with a multimedia capturing device through a wireless access point provided by the multimedia capturing device;
establishing, by the mobile application, a second communication link with a multimedia processing server associated with an emergency management cloud server through a communication network;
receiving, by the mobile application, through the first communication link, a stream of multimedia generated by the multimedia capturing device; and
transmitting, by the mobile application, through the second communication link, the stream of multimedia generated by the multimedia capturing device to the multimedia processing server associated with the emergency management cloud server for transmission to an ESP.

2. The method of claim 1, wherein the user device is operated by an emergency responder or a user in an emergency.

3. The method of claim 1, wherein the stream of multimedia is a pre-recorded stream of multimedia.

4. The method of claim 1, wherein the stream of multimedia is real-time or near real-time feed generated by a camera.

5. The method of claim 4, wherein the stream of multimedia is a one-way flow of audio and video feed.

6. The method of claim 4, wherein the stream of multimedia is a two-way flow of audio and video feed.

7. The method of claim 1, further comprising establishing, by the mobile application, a third communication link with a channel bonding server associated with the emergency management cloud server through the communication network, wherein the channel bonding server manages reception of the stream of multimedia by the mobile application from the multimedia capturing device through the first communication link and the transmission of the stream of multimedia from the mobile application to the multimedia processing server through the second communication link.

8. The method of claim 7, further comprising establishing, by the mobile application, a virtual private network (VPN) between the user device and the channel bonding server, wherein the channel bonding server manages reception of the stream of multimedia by the mobile application from the multimedia capturing device through the first communication link and the transmission of the stream of multimedia from the mobile application to the multimedia processing server through the second communication link through the VPN, wherein the channel bonding server is provided by the emergency management cloud server.

9. The method of claim 1, wherein the stream of multimedia is displayed on a graphical user interface (GUI) at the ESP.

10. The method of claim 9, wherein the cloud server initiates the stream of multimedia from the multimedia capturing device in response to receiving a selection of a multimedia request prompt from within the GUI at the ESP by an ESP user.

11. The method of claim 10, wherein a web link is sent to the user device via a message in response to the selection of the multimedia request prompt for initiating the stream of multimedia from the multimedia capturing device.

12. The method of claim 9, wherein the GUI comprises interactive elements for an ESP user to use for one or more of turning on, turning off, muting, blurring, repositioning and zooming the stream of multimedia.

13. The method of claim 1, wherein the stream of multimedia is transmitted by the mobile application to the multimedia processing server or by the multimedia capturing device to the mobile application through a first protocol and transmitted from the multimedia processing server to the ESP or by the mobile application to the multimedia processing server through a second protocol.

14. The method of claim 13, wherein the first protocol is one of real-time streaming protocol (RTSP) and real-time messaging protocol (RTMP).

15. The method of claim 13, wherein the second protocol is one of web real-time communication protocol (WebRTC) and HTTP live streaming protocol (HLS).

16. A system for sharing multimedia from a user device with an emergency service provider (ESP), the system comprising:
a multimedia capturing device, configured to:
provide a wireless access point;
generate a stream of multimedia; and
transmit the stream of multimedia to a mobile application executed on a user device;
the mobile application, executed on the user device and configured to:
establish a first communication link with the multimedia capturing device through the wireless access point;
establish a second communication link with a multimedia processing server associated with an emergency management cloud server through a communication network;
receive, through the first communication link, the stream of multimedia from the multimedia capturing device; and
transmit, through the second communication link, the stream of multimedia to the multimedia processing server; and
the multimedia processing server associated with the emergency management cloud server, configured to transmit the stream of multimedia to an ESP.

17. The system of claim 16, wherein the user device is operated by an emergency responder.

18. The system of claim 16, wherein the user device is operated by a user in an emergency.

19. The system of claim 18, wherein the ESP further transmits the multimedia stream to an emergency responder.

20. The system of claim 18, wherein the user device prompts an emergency responder or a user in an emergency to provide consent for sharing the stream of multimedia.

21. The system of claim 16, wherein the multimedia device is an external camera associated with the user device.

22. The system of claim 16, wherein the wireless access point provided by the multimedia capturing device does not provide internet access.

23. The system of claim 16, wherein the mobile application is further configured to establish a third communication link with a channel bonding server associated with the emergency management cloud server through the communication network, wherein the channel bonding server manages reception of the stream of multimedia by the mobile application from the multimedia capturing device through the first communication link and the transmission of the stream of multimedia from the mobile application to the multimedia processing server through the second communication link.

24. The system of claim 23, wherein the mobile application is further configured to establish a virtual private network (VPN) between the user device and the channel bonding server, wherein the channel bonding server manages reception of the stream of multimedia by the mobile application from the multimedia capturing device through the first communication link and the transmission of the stream of multimedia from the mobile application to the multimedia processing server through the second communication link through the VPN, wherein the emergency management cloud server comprises the channel bonding server.

25. The system of claim 16, wherein the mobile application is further configured to receive the stream of multimedia from the multimedia capturing device in response to receiving a multimedia request from within a graphical user interface (GUI) of the ESP.

26. The system of claim 25, wherein the mobile application is further configured to receive a multimedia request from the ESP on a user device of an emergency responder.

27. The system of claim 16, wherein the mobile application is further configured to transmit the stream of multimedia, via a first protocol, to the multimedia processing server or by the multimedia capturing device to the mobile application, and transmit the stream of multimedia, through a second protocol, from the multimedia processing server to the ESP or by the mobile application to the multimedia processing server.

28. The system of claim 27, wherein the first protocol is one of real-time streaming protocol (RTSP) and real-time messaging protocol (RTMP).

29. The system of claim 27, wherein the second protocol is one of web real-time communication protocol (WebRTC) and HTTP live streaming protocol (HLS).

30. The system of claim 27, wherein the mobile application is further configured to utilize a transcoder software library for one or more tasks such as adjusting bitrate, resolution, and frame rate of the stream of multimedia.
